(19) United States
(12) Patent Application Publication
(10) Pub. No.: US 2025/0265100 A1
(43) Pub. Date: Aug. 21, 2025

(54) USER INTERFACES FOR VIEWING REPRESENTATIONS OF EVENTS ON ELECTRONIC DEVICES

(71) Applicant: Apple Inc., Cupertino, CA (US)

(72) Inventors: Brian K. SHIRAISHI, Belmont, CA (US); Christopher J. ELLINGFORD, Alameda, CA (US); Nicolas C. EBERIENOS, Torrance, CA (US)

(21) Appl. No.: 19/060,361

(22) Filed: Feb. 21, 2025

Related U.S. Application Data
(60) Provisional application No. 63/556,328, filed on Feb. 21, 2024.
(60) Provisional application No. 63/674,243, filed on Jul. 22, 2024.

(51) Int. Cl. G06F 9/451; G06F 3/0482; G06F 3/0485

(52) U.S. Cl. CPC G06F 9/451; G06F 3/0482; G06F 3/0485

(57) ABSTRACT

In some embodiments, an electronic device displays a content user interface for viewing representations of events. In some embodiments, the electronic device displays representation of events associated with an organization in list of organizations with higher priority than representations of events not associated with an organization in the list of organizations. In some embodiments, the representation of events is selectable to view a user interface including additional information about the respective event including a representation of a progression of the event. In some embodiments, while displaying a user interface including additional information about a respective event, the electronic device detects an input, and as a result, the electronic device displays a second user interface including additional information about a second respective event.

### CROSS REFERENCE TO RELATED APPLICATIONS

This application claims the benefit of U.S. Provisional Application No. 63/674,243, filed Jul. 22, 2024 and U.S. Provisional Application No. 63/556,328, filed Feb. 21, 2024, the contents of which are herein incorporated by reference in their entireties for all purposes.

### FIELD OF THE DISCLOSURE

This disclosure relates generally to an electronic device presenting user interfaces for viewing representations of events on electronic devices.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to use such devices to view a plurality of representations of events. The user may therefore desire efficient ways of viewing representations of events.

### SUMMARY OF THE DISCLOSURE

Providing efficient ways of viewing and searching for events associated with user-designated organizations and events not associated with user-designated organizations improves a user's experience with the electronic device by reducing the inputs needed to view and search for events thus saving power and/or other computing resources of the electronic device. By being able to view events associated with favorited or designated organizations (e.g., teams, leagues, and associations) before other events, a user can quickly and easily navigate to live and upcoming events for which they are interested.

In some embodiments, an electronic device displays a content user interface for viewing representations of events. In some embodiments, the electronic device displays representation of events associated with an organization in list of organizations with higher priority than representations of events not associated with an organization in the list of organizations. In some embodiments, the representation of events is selectable to view a user interface including additional information about the respective event including a representation of events (e.g., plays and/or drives) occurring during the respective event. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G are block diagrams of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6J illustrate exemplary ways in which an electronic device generates a content user interface and displays representations of events in various ways in response to an input directed to the content user interface in accordance with some embodiments of the disclosure.

FIG. 7 illustrates a flow diagram illustrating a method in which an electronic device generates a content user interface and displays representations of events in various ways in response to an input directed to the content user interface in accordance with some embodiments of the disclosure.

FIG. 8 illustrates a flow diagram illustrating a method in which an electronic device displays user interfaces including additional information about an event in response to an input in accordance with some embodiments of the disclosure.

FIGS. 9A-9K illustrate exemplary ways in which an electronic device generates a representation of a live event that updates as the live event progresses in accordance with some embodiments of the disclosure.

FIG. 10 illustrates a flow diagram illustrating a method in which an electronic device generates a representation of a live event that updates as the live event progresses in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of viewing representations of events including events associated with organizations in a list and events not associated with organizations in a list improves a user's experience with the electronic device by reducing the inputs needed to view the events including organizations in the list of organizations before other events thus saving power and/or other computing resources of the electronic device.

In some embodiments, an electronic device displays a content user interface for viewing representations of events. In some embodiments, the electronic device displays representation of events associated with an organization in list of organizations with higher priority than representations of events not associated with an organization in the list of organizations. In some embodiments, the representation of events is selectable to view a user interface including additional information about the respective event including a representation of events (e.g., plays and/or drives) occurring during the respective event.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

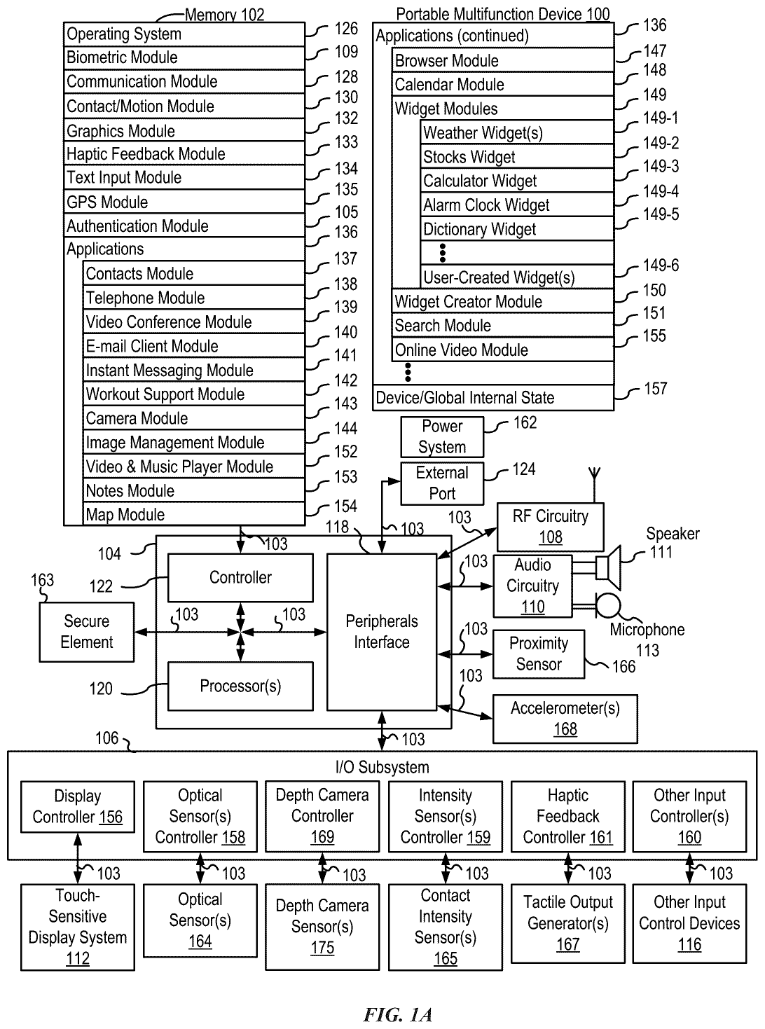

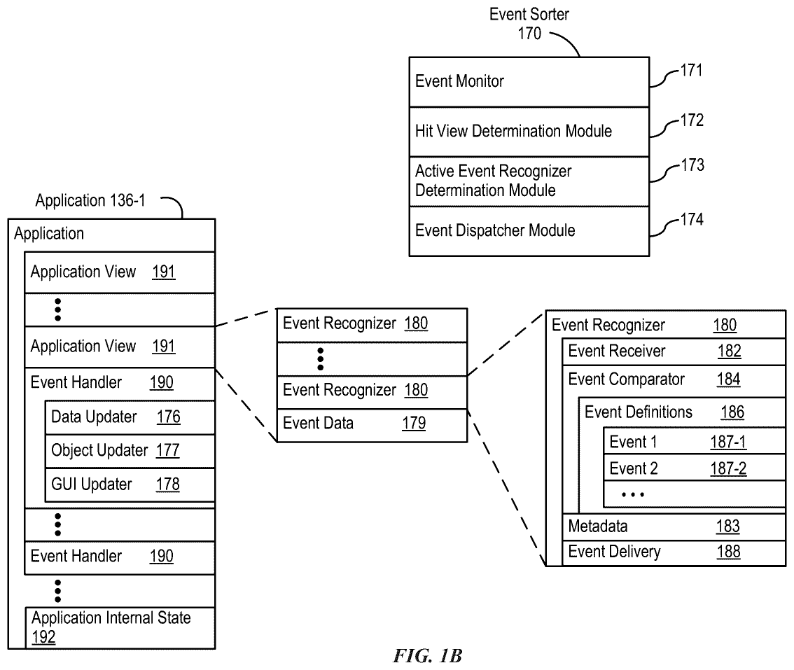

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

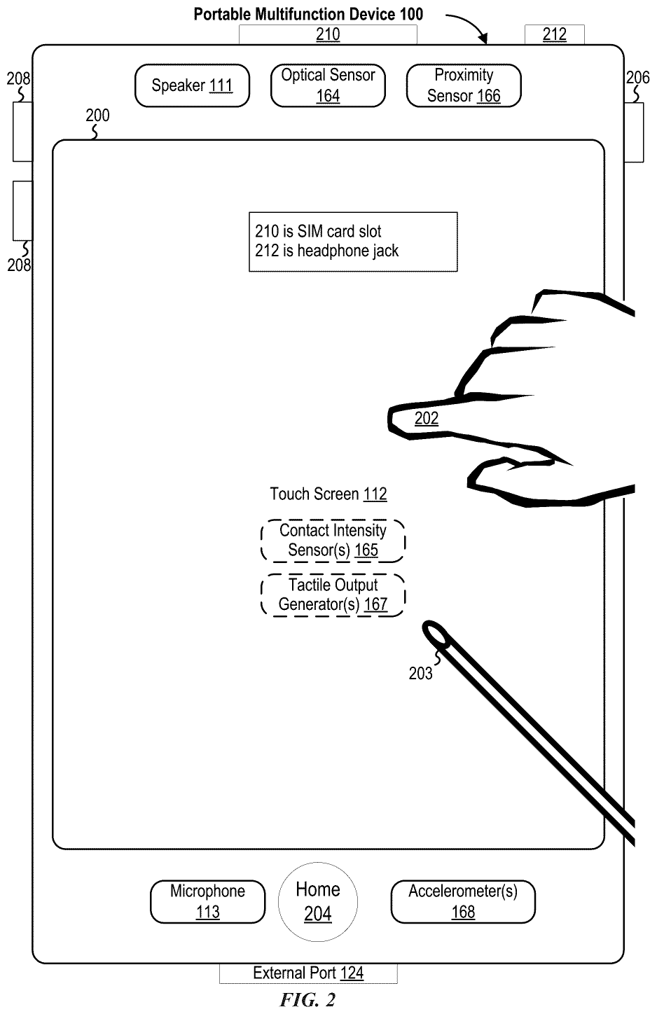

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

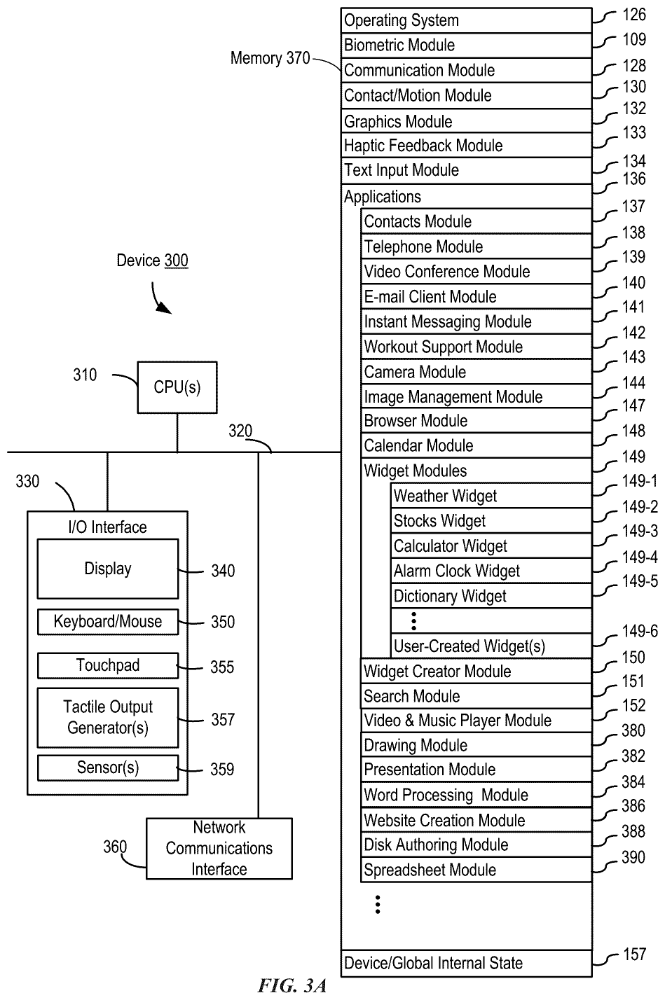

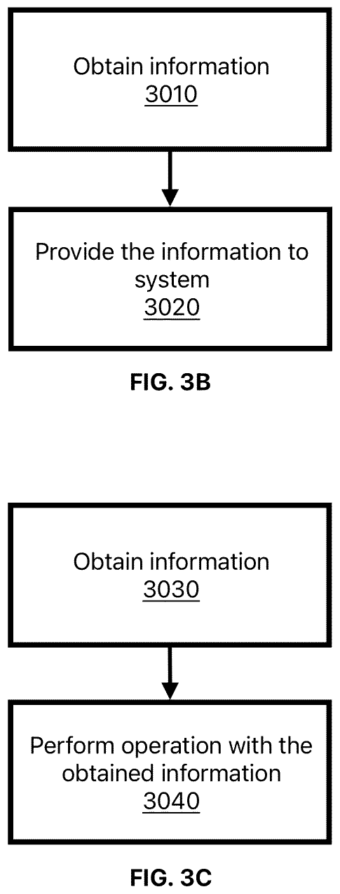

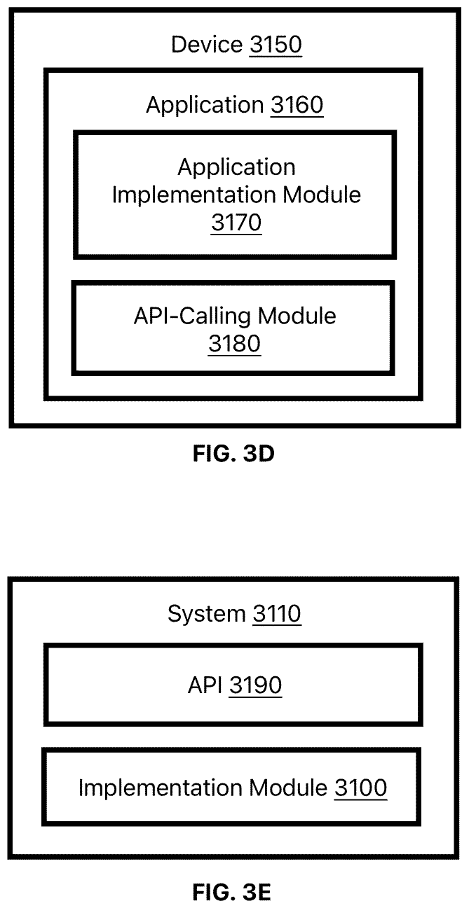

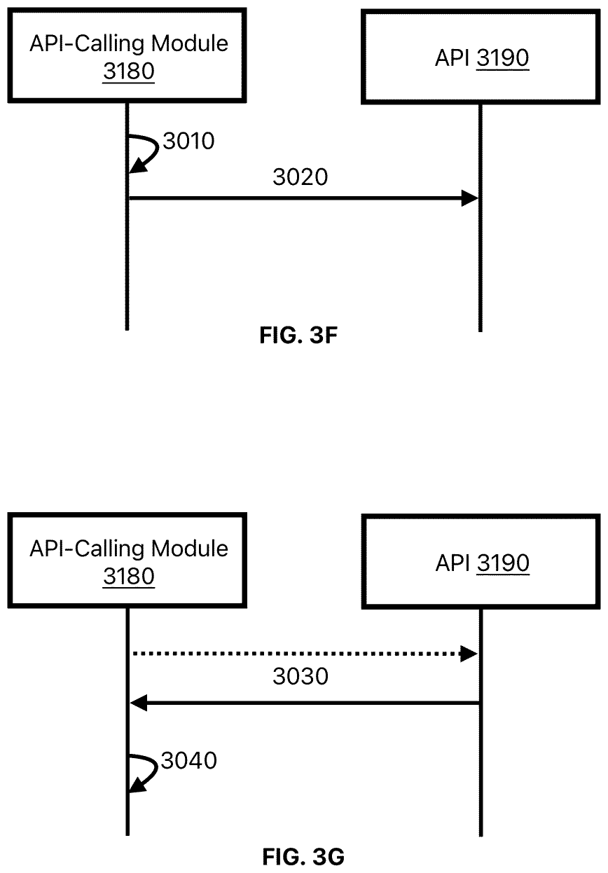

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, instant messaging (IM) module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or instant messaging (IM) module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

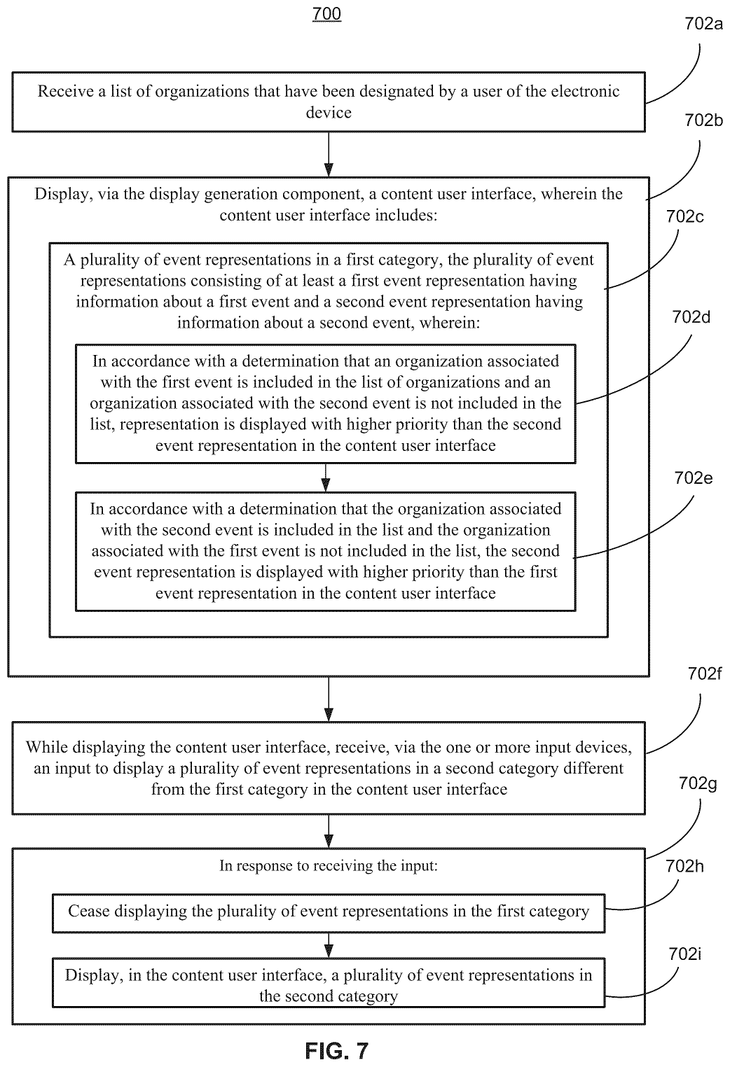

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

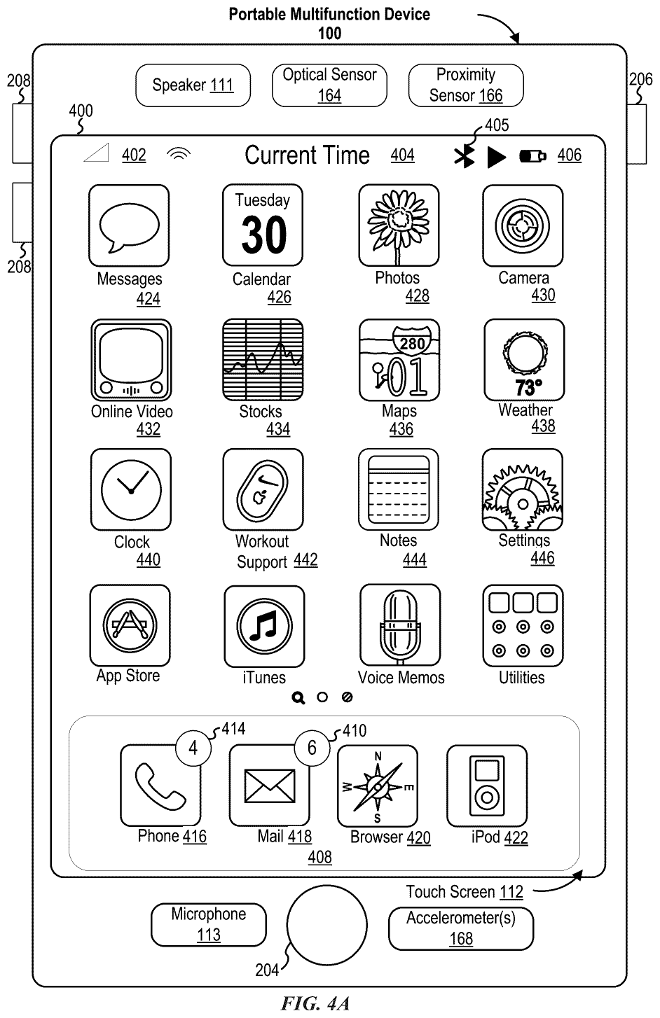

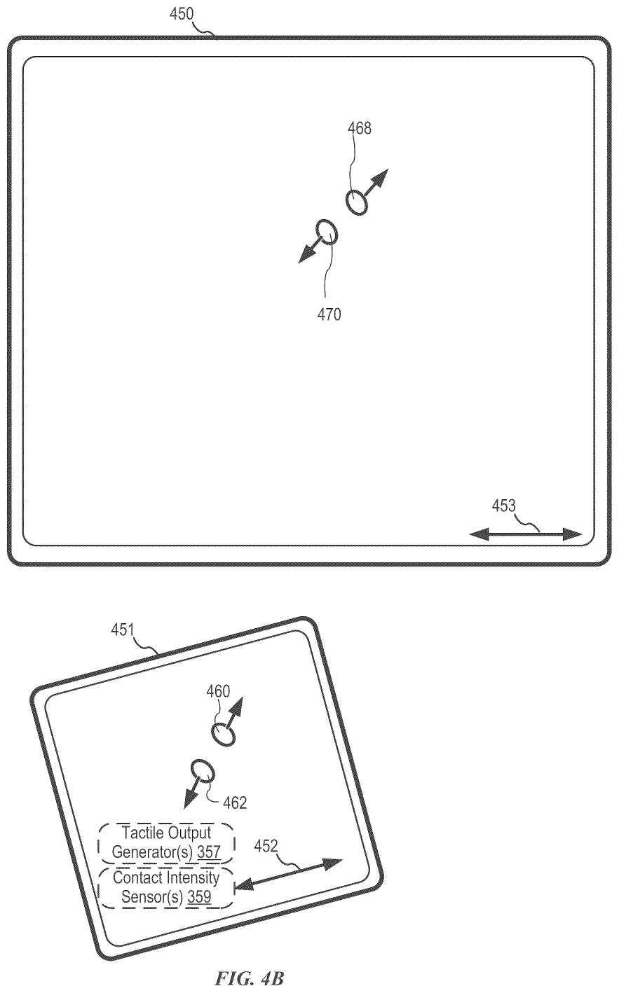

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

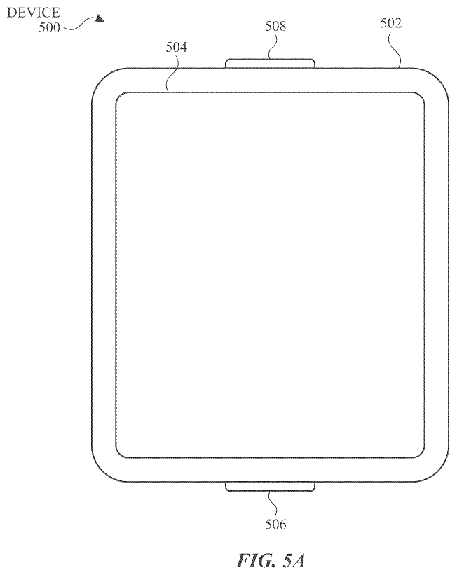

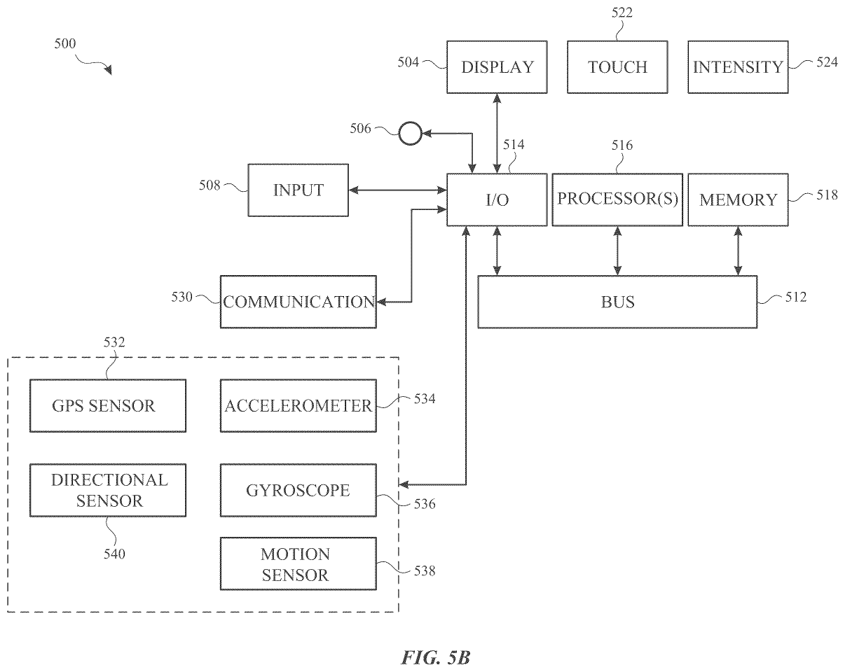

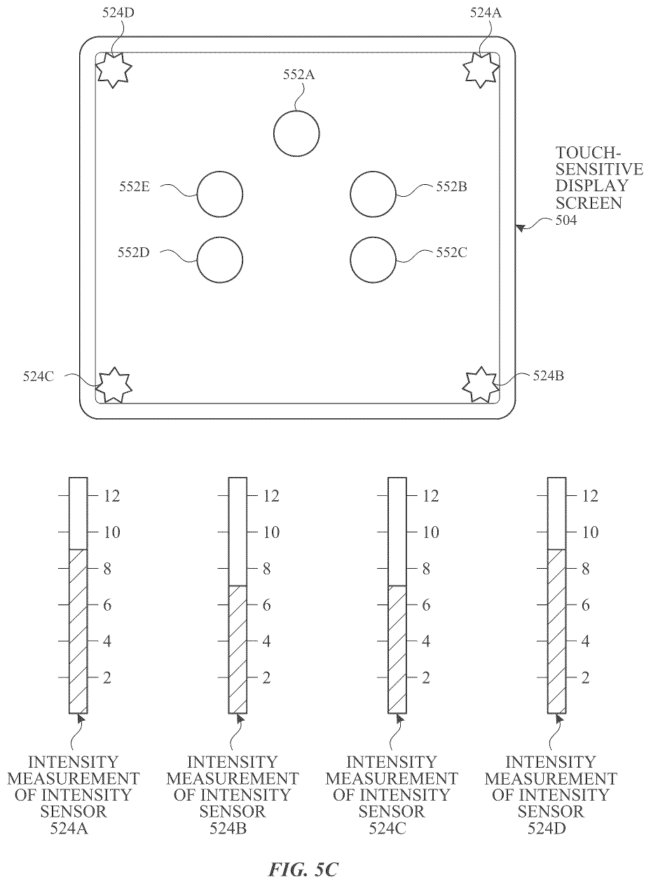

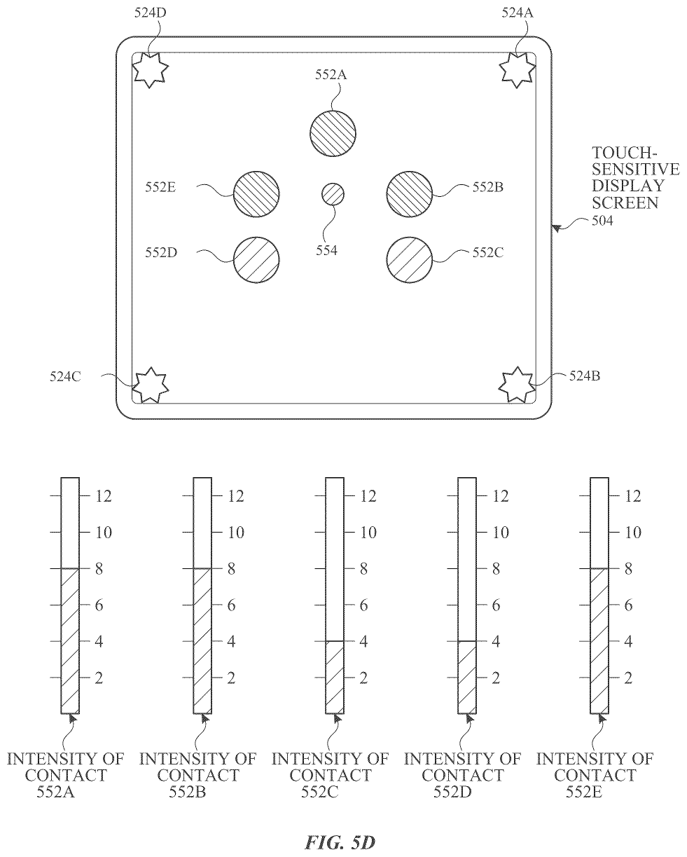

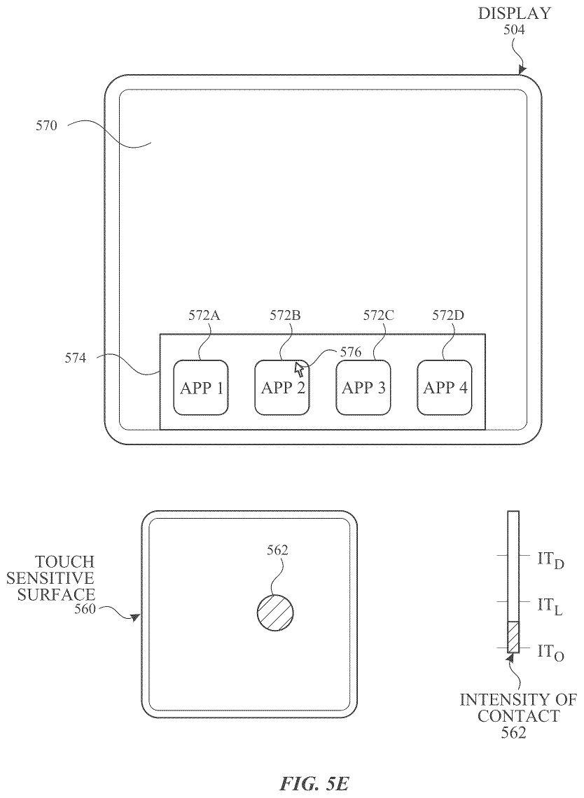

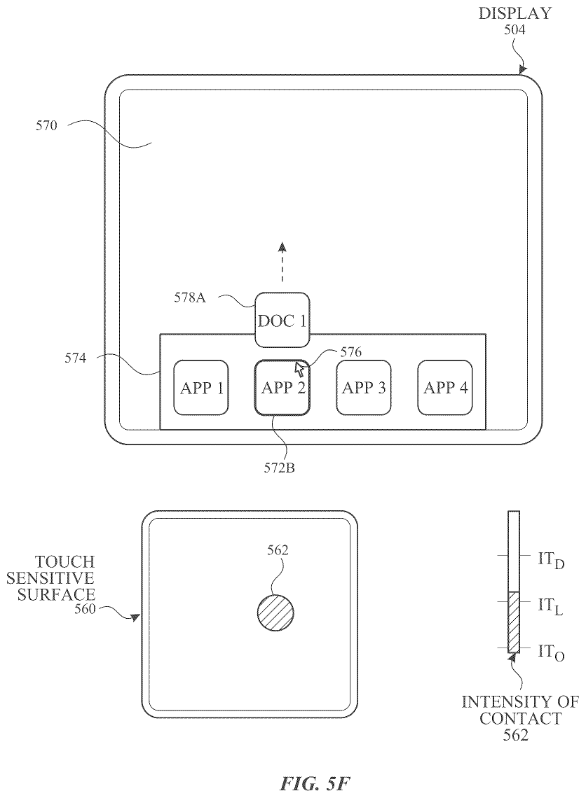

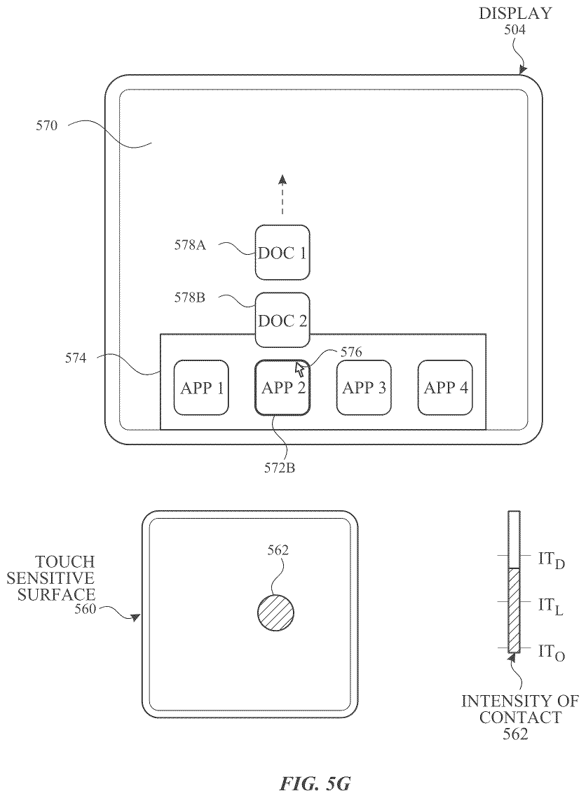

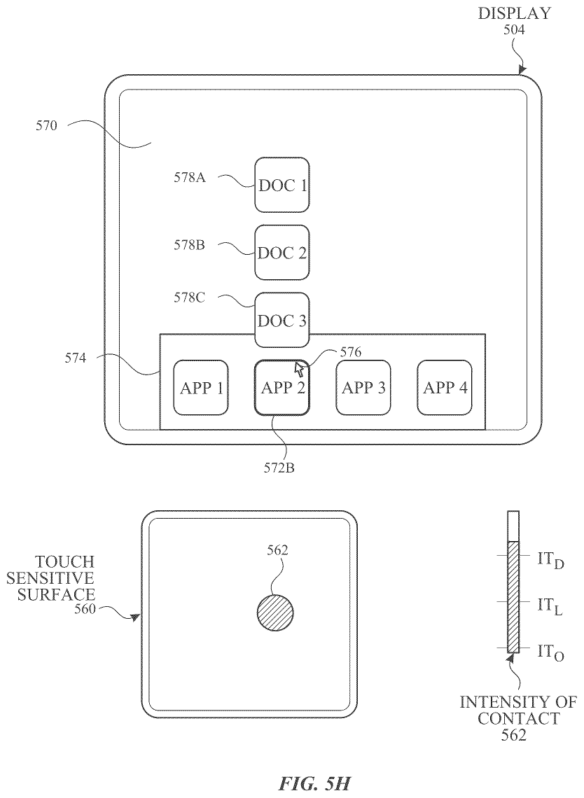

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., methods 700, 800, and/or 1000). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### Viewing Representations of Events Using a Content User Interface

Users interact with electronic devices in many different manners. In some embodiments, an electronic device is connected to one or more input devices and a display generation component. In some situations, a user of the electronic device wants to view information about a plurality of events (e.g., sporting events) at once. In some embodiments, the electronic device displays a content user interface that allows a user to view a plurality of different categories of events. For example, the content user interface includes a display of a plurality of indications of events in a first category and a plurality of indications of events in a second category. In some embodiments, the content user interface includes a plurality of events that are categorized in various ways, including by time the event is occurring, by the type of event that is occurring (e.g., which sport the event is associated with), and/or by the league of sports that the event is associated with. The embodiments described below provide ways in which an electronic device displays the content user interface with events including events associated with teams and/or sports leagues that are of interest to a user (e.g., favorited by a user) along with other events in time chronological order. Displaying a user interface that includes events including organizations included in the list of organizations (e.g., teams and/or leagues that have been favorited by a user) over events that do not include organizations in the list of organizations reduces erroneous or extra inputs to the electronic device to view the events including organizations in the list of organizations before other events. It is understood that people use devices. When a person uses a device, that person is optionally referred to as a user of the device.

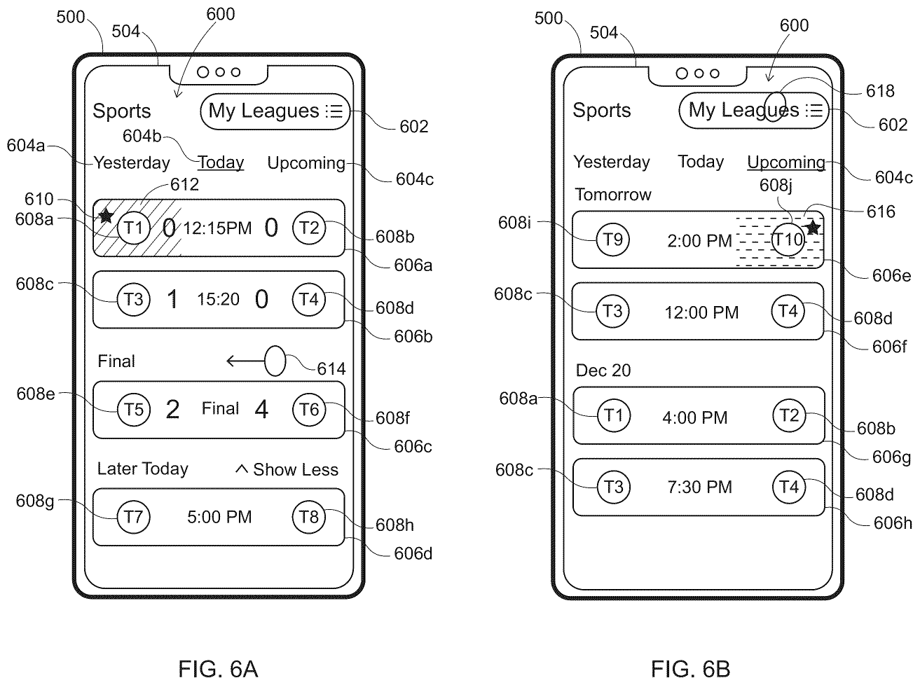

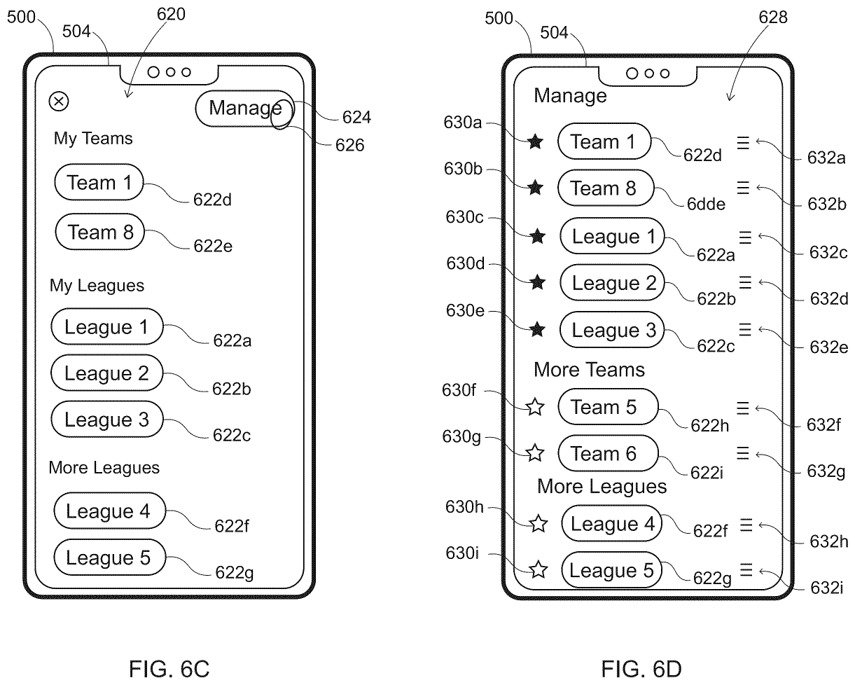

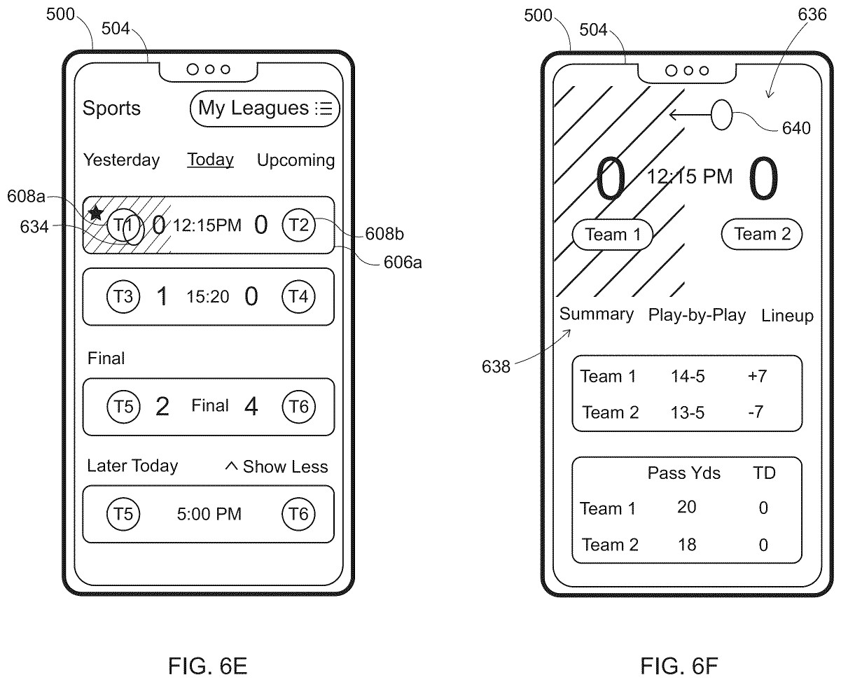

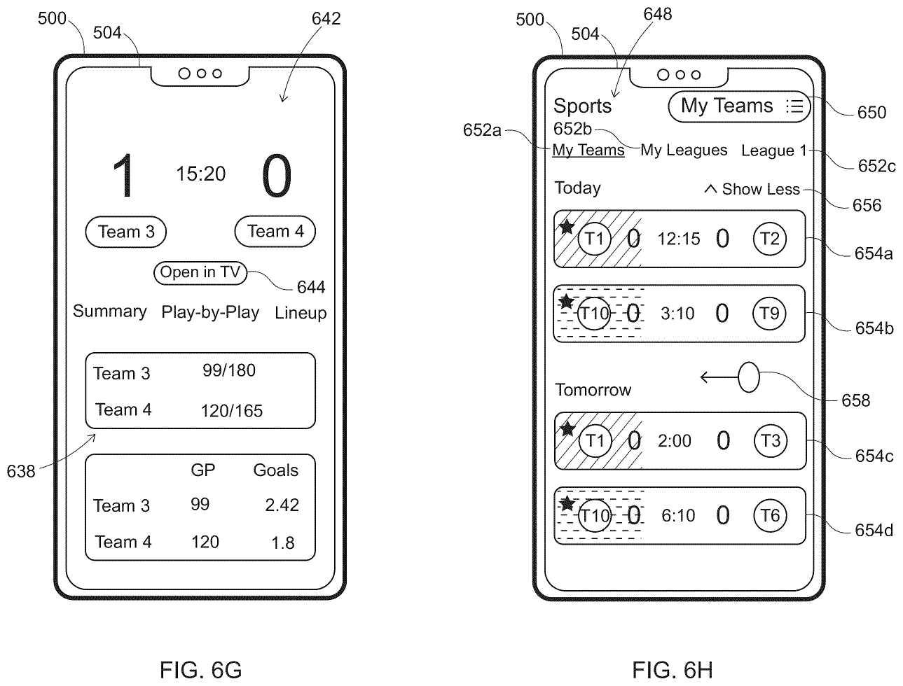

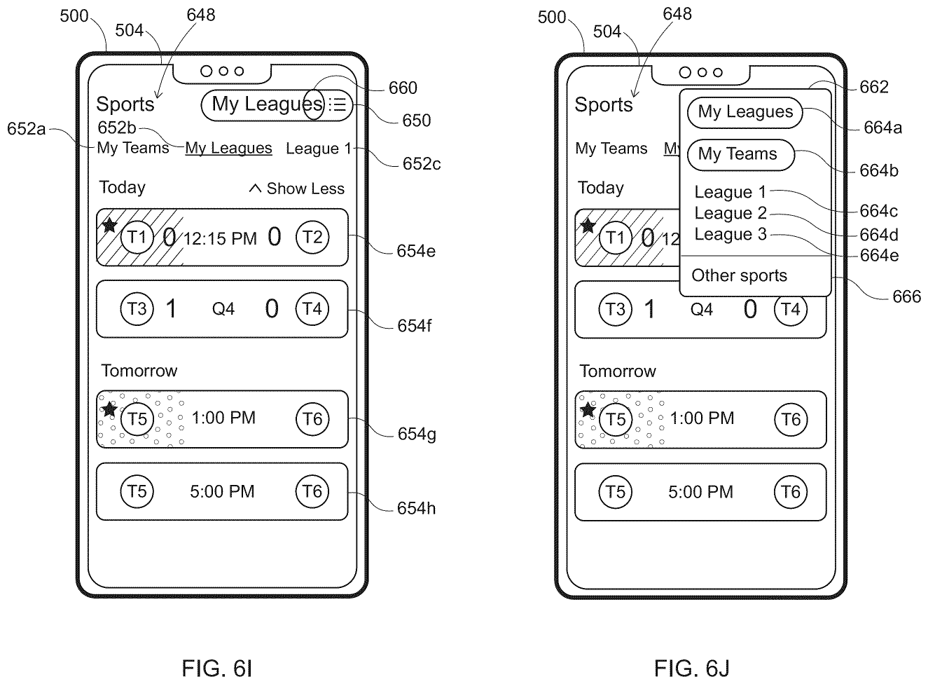

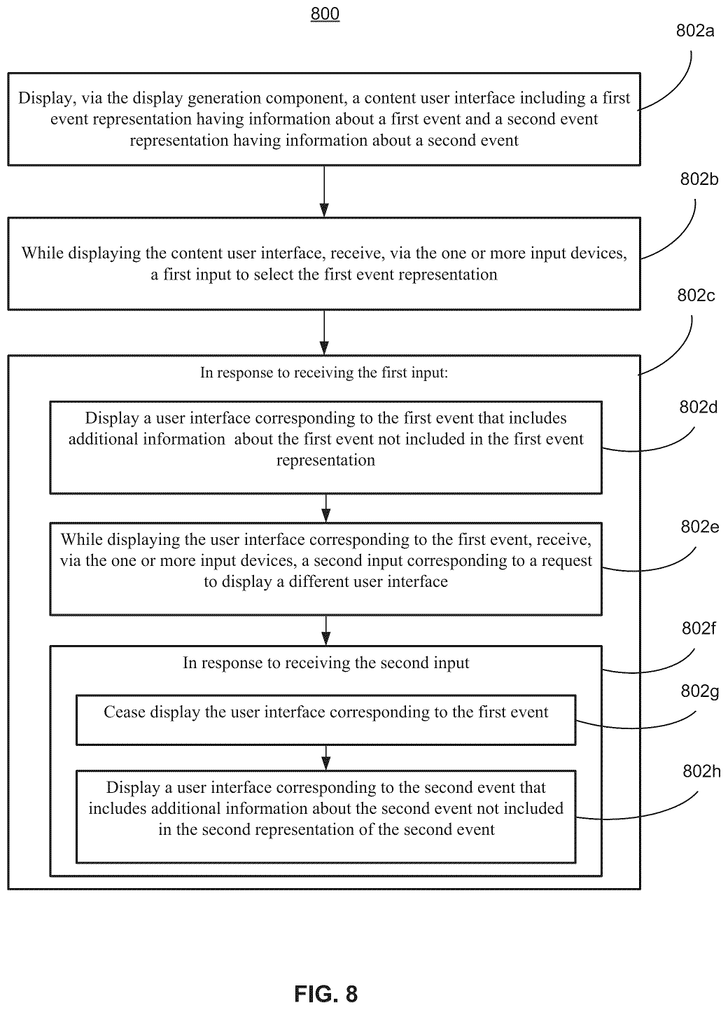

FIGS. 6A-6J illustrate exemplary ways in which an electronic device generates a content user interface and displays representations of events (e.g., live and upcoming sports events) in various ways in response to an input directed to the content user interface. The embodiments in these figures are used to illustrate the processes described below, including the processes described with reference to FIG. 7. Although FIGS. 6A-6J illustrate various examples of ways an electronic device is able to perform the processes described below with respect to FIG. 7 and FIG. 8, it should be understood that these examples are not meant to be limiting, and the electronic device is able to perform one or more processes described below with reference to FIG. 7 and FIG. 8 in ways not expressly described with reference to FIGS. 6A-6J.

FIG. 6A illustrates an electronic device 500 with a display generation component 504. In some embodiments, the electronic device 500 is a mobile device, such as a smartphone, tablet, or wearable device. In some embodiments, electronic device 500 includes a content (e.g., playback, browsing, streaming, and/or sharing) application. In some embodiments, the content application is a music, podcast, video (e.g., live event content and/or on-demand content), article or other content application, as described with reference to method 700. In some embodiments, the content application includes user interface 600, which includes indications and/or information about the video content, live event content, on-demand content, or other content, described in greater detail below and in method 700. In some embodiments, the user interface 600 is a home page user interface of the content application. For example, user interface 600 is optionally the first user interface displayed after opening the content application. In some embodiments, the user interface 600 is displayed in response to receiving one or more inputs navigating the content application user interfaces.

In some embodiments, the user interface 600 includes a user interface element 602, that includes text (e.g., “My Leagues”) that describes a particular category with which the events on the user interface 600 are associated. As shown in FIG. 6A, the events listed (e.g., user interface elements 606a through 606d, described in further detail below) are associated with “My Leagues”. In some embodiments, the category, “My Leagues”, includes one or more leagues that have been added by the user to a list of organizations (e.g., the user has favorited leagues or added them to the “My Leagues” list). The process of adding organizations and categories is described in further detail herein and in method 700. In some embodiments, the list of organizations is a favorites list of organizations which the user would like to follow. For example, a user is may be interested in particular teams and leagues (e.g., the San Francisco 49'ers or the National Football League) so the user adds those teams and/or leagues to a favorites list. In some embodiments, the electronic device 500 displays organizations and events associated with organizations in the favorites list separately and/or differently than other events and organizations, as described below. In some embodiments, the “My Leagues” category includes events associated with leagues that have been favorited by the user. (e.g., previous, upcoming, or now-playing sports events associated with the National Football League) In some embodiments, user interface 600 also includes a “My Teams” category which includes events associated with teams that have been favorited by the user (e.g., previous, upcoming, or now-playing events associated with the San Francisco 49'ers). In some embodiments, the user interface 600 includes user interface elements 604a through 604c illustrating a second category associated with the events (e.g., user interface elements 606a through 606d). In some embodiments, the electronic device 101 indicates the category of events that is currently being displayed by displaying an additional representation under the user interface element. For example, in FIG. 6A, the events are associated with “My Leagues” as well as “Today”, because a line (e.g., the additional representation) is shown under user interface element 604b. In some embodiments, the user interface elements 604a through 604c further categorize the events by date (e.g., “yesterday”, “today”, and “upcoming”), as described further in FIG. 6B.

In some embodiments, the user interface 600 includes a plurality of user interface elements 606a through 606d that represent the events that are occurring today and that are associated with “My Leagues” (e.g., the leagues that are in the list of organizations selected or designated by the user). In some embodiments, user interface elements 606a through 606d include respective indications of the teams participating in the event (e.g., indications 608a through 608h). For example, user interface element 606a, representing a first event, includes indications 608a through 608b, representing teams “T1” and “T2”, which are the teams participating in the first event. User interface element 606b, representing a second event, includes indications 608c through 608d, representing teams “T3” and “T4”, which are the teams participating in the second event. User interface element 606c, representing a third event, includes indications 608e through 608f representing teams “T5” and “T6”, which are the teams participating in the third event. User interface element 606d, representing a fourth event, includes indications 608g through 608h representing teams “T7” and “T8”, which are the teams participating in the fourth event. Furthermore, user interface elements 606a through 606d include additional information relevant to the respective events (e.g., start time, finish score, time remaining). For example, user interface element 606a includes the start time “12:15 PM” because the event has not occurred yet, user interface element 606b includes the time remaining “15:20” because the event is currently occurring, user interface element 606c includes “Final” because the event has already occurred today, and user interface element 606d includes the start time “5:00 PM” because the event has not occurred yet. In some embodiments, the user interface elements 606a through 606d include other additional information, such as betting odds for each given team or other sport/team specific information.

In some embodiments, the events are ordered such that events including teams that are favorited are displayed first (e.g., at the top of the user interface). For example, in FIG. 6A, user interface element 606a is displayed at the top of the user interface although the event is not occurring until later in the day, because “T1” is favorited by the user (e.g., T1 is in the list of organizations, as described in greater detail in method 700). In some embodiments, the electronic device 500 displays an indication 610 next to the indication 608a to indicate that the team is in the list of organizations. Additionally, the electronic device 500 displays teams (and other organizations) that are included in the list of organizations with different visual characteristics, e.g., coloring. As shown in FIG. 6A, team T1 is displayed with shading 612. Shading 612 optionally represents the colors of team T1.

FIG. 6A illustrates an embodiment in which the events with teams in the list of organizations (e.g., favorited teams) are displayed with priority, e.g., shown first in a list of events on the display, followed by actively occurring events (e.g., user interface element 606b), then events that have occurred today (e.g., user interface element 606c), and finally events that will occur later in the day (e.g., user interface element 606d). In some embodiments, and as described in method 700, within the sub-categories, the events are organized in chronological order. In some embodiments, the events that have occurred today sub-category is unique to the “today” category, as events that are upcoming have not occurred yet and events that occurred yesterday have all already occurred.

In some embodiments, the electronic device 500 detects a left swipe input from a user (e.g., using contact 614). In response to detecting the left swipe, the electronic device 101 updates the content user interface 600 to display events in a second category (e.g., “Upcoming”) of the “My Leagues” category, as shown in FIG. 6B. For example, in response to detecting the left swipe input, the electronic device 500 displays user interface elements 606e through 606h, representing events that are upcoming within the “My Leagues” category (e.g., indicated by user interface element 602). As shown in FIG. 6B, as a result of detecting the input, the electronic device 500 switches the currently-displayed user interface from “Today” to “Upcoming”, visually distinguishing (e.g., underlines) user interface element 604c, representing the category “upcoming” to show that “Upcoming” is the currently-displayed user interface and ceasing visually distinguishing (e.g., underlining) user interface element 604b, representing the category “today.” As described above, user interface elements 606e through 606h include respective indications of the teams participating (e.g., indications 608a through 608j) in corresponding events. In some embodiments, and as described above, events associated with organizations (e.g., teams) that are in the list of designated organizations (e.g., favorites list) include an additional indication 610 indicating that the team is in the list. As shown in FIG. 6B, user interface element 606e is an event between teams T9 and T10, where team T10 is part of the list of designated organizations. As such, the electronic device 500 displays indication 610 next to indication 608j and displays shading 616 to visually indicate that team T10 is part of the list of organizations. In some embodiments, shading 616 includes one or more colors associated with team T10 and/or one or more visual elements selected by the user to represent team T10. For example, shading 616 optionally includes icons, words, colors, banners, and/or other visual elements. In some embodiments, and as described in method 700, representations of the events associated with organizations in the list of organizations are prioritized (e.g., listed before the other events) in the user interface and organized chronologically, and the other events are listed chronologically below the representations of the events associated with organizations in the list of organizations. As shown in FIG. 6B, user interface element 606e is listed first because team T10 is in the list of organizations, and the following user interface elements 606f through 606h are listed in chronological time order such that representations of the events occurring the soonest are listed before representations of the events occurring later.

While display user interface 600 in FIG. 6B, the electronic device 500 receives an input directed towards user interface element 602. In response to receiving the input illustrated in FIG. 6B, the electronic device 101 displays user interface 620, shown in FIG. 6C, which includes a display of the categories with which an event can be associated. For example, and as described in method 700, the user interface 620 includes a list of associations of teams (e.g., sports leagues) and/or sports teams that are associated with the events displayed on user interface 600. In some embodiments, electronic device 500 displays visual indications 622a through 622g to illustrate the categories including events (e.g., teams and leagues). In some embodiments, visual indications 622a through 622g includes text indicating the team or league. In some embodiments, the visual indications 622a through 622g are organized such that organizations in the list of organizations (e.g., teams and leagues that have been favorited by a user) are listed first before the other organizations are listed. For example, in FIG. 6C, indications 622a through 622c represents the leagues that have been favorited by the user, indications 622d through 622e represent the teams that have been favorited by the user, and indications 622f through 622g represent other leagues that have not been favorited by the user.

In some embodiments, the user interface 620 includes a selectable option 624. In some embodiments, the electronic device 500 displays an editing user interface 628 that allows a user to change the order that the organizations are displayed in user interface 620 and allows a user to add organizations to the list of designated organizations. In FIG. 6C, the electronic device 500 receives a tap input using contact 626 directed towards selectable option 624. In response to receiving the input illustrated in FIG. 6C, the electronic device displayed editing user interface 628, shown in FIG. 6D. In some embodiments, a tap input, as described herein, is optionally an air-tap gesture such as a gaze with a user's eyes and/or an air-pinch gesture. In some embodiments, selection inputs are described in greater detail in methods 700 and 900.

FIG. 6D illustrates the editing user interface 628 that includes a plurality of selectable options to modify the presentation of the organizations/categories in the user interface 620. In some embodiments, the electronic device 500 displays the organizations such that favorited organizations (e.g., leagues and teams) are presented with higher priority within (e.g., at the top of) the list and the other organizations are presented with lower priority within (e.g., below in) the editing user interface 628. In some embodiments, the organizations are separated by team or league and favorited or not favorited. For example, in FIG. 6D, indications 622a through 622i indicates the type of organization and indications 630a-630i indicate whether the organization is a favorited organization. As shown in FIG. 6D, the representations of organizations (e.g., indications 622a through 622i) include corresponding indications 630a through 630i and corresponding indications 632a through 632i. In some embodiments, indications 630a through 603i indicate whether the corresponding organization is in the list of organizations. For example, indications 630a through 630e are shaded in because the corresponding organizations, represented by indications 622a through 622e, are in the list of organizations. Comparatively, indications 630f through 630i are not shaded in because the corresponding organizations, represented by indications 622f through 322i are not in the list of organizations. In some embodiments, the electronic device uses a visual characteristic other than shading or not shading indications 630a through 630i to distinguish whether or not the corresponding organizations are included in the list of organizations. Additionally, as shown in FIG. 6D, indications 622a through 622i also include corresponding indications 632a through 632i. In some embodiments, the electronic device 500 changes the order of the organizations in response to detecting a dragging input on indications 632a through 632i. For example, a user can rearrange the leagues and teams (e.g., moving team 8 before team 1, or moving league 5 to be below league 3) by selecting the corresponding indication 632a through 632i and while selecting the indication, dragging the contact to a different location on the user interface 628. In response to detecting that the indication is no longer selected (e.g., the contact is no longer in contact with the touchscreen), the electronic device displays the selected indications at the location at which selection of the indication was released. In some embodiments, in response to detecting the user move an organization to the location of list of organizations on user interface 628 using the indications 632a through 632i, the electronic device additionally adds the associated organization to the list of organizations and shades the corresponding indication 630a through 630f to indicate that the organization is in the list of organizations.

FIG. 6E illustrates the user interface 600, as described in FIG. 6A. In FIG. 6E, the electronic device 500 receives an input using contact 634 directed towards user interface element 606a. In response to receiving the input illustrated in FIG. 6E, the electronic device 500 displays user interface 636, which provides additional information about the event associated with user interface element 606a, shown in FIG. 6F. Additional details about displaying additional information about the event is described in method 800.

FIG. 6F illustrates an expanded user interface 636 of the event corresponding to the user interface element 606a selected in FIG. 6E. In some embodiments, user interface 636 includes indications of the teams playing in the event and the start time of the event (e.g., the information shown on user interface element 606a in FIG. 6E). In some embodiments, user interface 636 includes additional relevant information about the event, such as a summary of the teams' statistics for the current season, and other information that is specific to the event, the sport that the teams are playing, to the players of the teams (e.g., individual player statistics), and/or to the league that the teams are a part of. In some embodiments, the electronic device displays additional information in area 638, including tabs that a user can swipe through. For example, as shown in FIG. 6F, area 638 includes a “summary” tab, a “play-by-play” tab, and a “lineup” tab. In some embodiments, the electronic device displays different information in response to receiving an input including swiping (e.g., such as with a contact) left or right in the area 638. For example, the summary tab includes an overlook of the teams playing, including betting odds, the play-by-play tab includes statistics and information about the current play, and the lineup tab includes statistics and information about the players in each team. In some embodiments, other information for other sports and/or types of events are described with reference to method 800.

While displaying the user interface 636, the electronic device 500 receives a left swipe input using contact 640. As a result, the electronic device ceases displaying user interface 636 and displays user interface 642, shown in FIG. 6G. In some embodiments, user interface 642 includes additional information about the event corresponding to user interface element 606b, shown in FIG. 6E. As described in method 800, in response to receiving additional swipe inputs directed to user interfaces with more information about events, such as user interface 642, the electronic device 500 displays other user interfaces with additional information about other events in the order that they are displayed in user interface 600, shown in FIG. 6A and FIG. 6B. For example, in response to detecting the left swipe input shown in FIG. 6F on the user interface corresponding to the first event shown on FIG. 6E (e.g., user interface element 606a), the electronic device would display the user interface corresponding to the second event shown on FIG. 6E (e.g., user interface element 606b). In some embodiments, if the electronic device 500 detects a right swipe input on FIG. 6F, then the electronic device displays a user interface corresponding to the last event shown in the “Yesterday” category in FIG. 6E (e.g., the event that occurred before the event corresponding to user interface element 606a chronologically).

FIG. 6G illustrates the user interface 642 corresponding to the second event shown in FIG. 6E. For example, the second event (user interface element 606b) is the next event after the first event (user interface element 606a) in FIG. 6E. In some embodiments, user interface 642 includes one or more characteristics of user interface 636 described in FIG. 6F. In some embodiments, the second event is currently occurring. Because the second event is currently occurring, the electronic device 500 displays selectable option 644, which is selectable to display a user interface of a different application to play (e.g., stream) video of the event. The selectable option 644 is described in further detail in method 800. Additionally, in FIG. 6G, the electronic device 500 displays area 638 in user interface 642, which includes a plurality of relevant information for the event. For example, area 638 includes summary statistics of team 3 and team 4 including the average number of goals per game and the total number of goals scored by each team. Area 638 also includes different tabs such as a “summary” tab, a “play-by-play” tab, and a “lineup” tab. In some embodiments, the summary tab is shown in FIG. 6G and includes information about each team and their goal statistics. In some embodiments, the play-by-play tab includes information about the most recent goal. In some embodiments, the lineup tap includes information about the players in the teams, including statistics that are relevant to soccer. In some embodiments, the information in area 638 in FIG. 6G is different than the information in area 638 in FIG. 6F because the second event is related to a different activity (e.g., sport) than the first event. For example, the second event is related to soccer and the first event is related to football.

FIG. 6H illustrates a second embodiment of the user interface 600 that was also shown in FIGS. 6A-6B and FIG. 6E. In FIG. 6H, the electronic device displays user interface 648, which has one or more characteristics of user interface 600. In some embodiments, the user interface elements 654a through 654d includes one or more characteristics of the user interface elements 606a through 606d. For example, user interface elements 654a through 654d includes a corresponding visual indication of teams participating in the event, a visual indication of the teams that are favorited by the user, a visual indication of the score of the event, and a visual indication of the time (e.g., when the event will occur, the time remaining on the event, or that the event has finished). However, in FIG. 6H, the user interface elements 654a through 654d are organized and sorted in a different way than the user interface elements 606a through 606d, shown in FIG. 6A. In some embodiments, the electronic device 500 displays the events in user interface 648 by the category indicated by selectable option 650. Within a category, which is also indicated by user interface elements 652a through 652c (e.g., user interface element 652a is underlined and corresponds to the category shown on selectable option 650), the events are organized by date occurring (e.g., today and tomorrow). The electronic device 500 displays events corresponding to different dates (e.g., today, tomorrow, and upcoming (not displayed)) in response to detecting a swipe input up or down. For example, the electronic device displays upcoming events in user interface 648 in response to a swipe input to scroll downward and the electronic device displays events that occurred yesterday in user interface 648 in response to a swipe input upward. However, the electronic device 500 displays the events in user interface 600 (shown in FIG. 6A) firstly by the category indicated by user interface element 602 and secondly by the category indicated by user interface elements 604a through 604c. The electronic device displays events occurring on different dates (e.g., yesterday, today, upcoming) in response to left and right swipe inputs, as shown in FIGS. 6A-6B.

FIG. 6H illustrates representations of events in the “My Teams” category. As described above, and with reference to method 700, the representations of events are organized chronologically (e.g., within the events that include favorited teams and within events that do not include favorited teams). The electronic device displays selectable option 656 in user interface 648. In some embodiments, in response to detecting a tap input on selectable option 656, the electronic device “collapses” user interface elements 654a through 654b such that only user interface element 654a is shown to save screen real estate (e.g., the user wants to view events from other dates).

While displaying user interface 648 with representations of events in the “My Teams” category, the electronic device 500 detects a left swipe input using contact 658. In response to detecting the input, the electronic device 500 displays representations of events in a different category, as shown in FIG. 6I. In FIG. 6I, the electronic device 500 updates the text in selectable option 650 to “My Leagues”, and updates user interface elements 652a through 652c such that 652a is no longer underlined and 652b is underlined, in response to the input in FIG. 6H. In some embodiments, user interface element 652b corresponds to “My Leagues”. In some embodiments, if the electronic device 500 detects a right swipe input, then the electronic device displays events in a different category, described in further detail in method 700. For example, if the electronic device 500 is displaying events associated with user interface element 652c (e.g., “League 1”), and the electronic device 500 detects a right swipe input, then the electronic device 500 will begin displaying events associated with user interface element 652b (e.g. “My Leagues”).

FIG. 6I includes representations the events, represented by user interface elements 654e through 654h, that are associated with the category “My Leagues”. As described above, and in method 700, the representations of events are organized chronologically and the representations of events associated with favorited teams are displayed before the representations of other events in each sub-category (e.g., “today”, and “tomorrow”). While displaying the user interface 648 in FIG. 6I, the electronic device 500 receives an input (e.g., using contact 660) directed towards selectable option 650. As a result, the electronic device 500 displays menu 662, shown in FIG. 6J.

FIG. 6J illustrates the menu 662 displayed in user interface 648. In some embodiments, the menu 662 includes a list of categories 664a through 664e that are most relevant to the user, currently. In some embodiments, the categories are ordered by relevance to the user, as described in method 700. In some embodiments, the categories 664a through 664e are selectable. In response to detecting an input on one of the categories 664a through 664e, the electronic device updates user interface 648 with the events associated with the category selected. Menu 662 also includes selectable option 666. In response to detecting an input towards selectable option 666 in FIG. 6J, the electronic device 500 displays user interface 620 shown in FIG. 6C. In some embodiments, a user can edit the categories shown in menu 662 using editing user interface 628, shown in FIG. 6D. Additionally, in some embodiments, the categories 664a through 664e correspond to the text shown for user interface elements 652a through 562c in FIG. 6I. In some embodiments, as the electronic device 500 detects left swipe inputs, additional user interface elements will be displayed.

FIG. 7 is a flow diagram illustrating a method in which an electronic device generates a content user interface and displays representations of events in various ways in response to an input directed to the content user interface in accordance with some embodiments of the disclosure. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device displays representations of events associated with organizations in a list of organizations and events not associated with organizations in the list of organizations in an content user interface. Prioritizing events that include organizations included in the list of organizations over events that do not include organizations in the list of organizations reduces erroneous or extra inputs to the electronic device to view the events including organizations in the list of organizations before other events.

A method 700 is performed at an electronic device in communication with a display generation component and one or more input devices, such as at electronic device 500, shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, a hand tracking device, and/or a motion sensor (e.g., a hand tracking device, a hand motion sensor). In some embodiments, the hand tracking device is a wearable device, such as a smart glove. In some embodiments, the hand tracking device is a handheld input device, such as a remote control or stylus.

In some embodiments, the electronic device receives (702a) a list of organizations that have been designated by a user of the electronic device, such as the list of organizations shown by visual indications 622a through 622e in FIG. 6C. In some embodiments, the list of organizations is a favorites list. In some embodiments, a user designates particular organizations (e.g., sports teams and/or sports leagues) as part of the list of organizations, as described below.

In some embodiments, the electronic device displays (702b), via the display generation component, a content user interface, such as user interface 600, shown in FIG. 6A. In some embodiments, the content user interface is a user interface of a content application. In some embodiments, the content application displays indications of and/or information about video content, live event content, on-demand content, or other visual content. In some embodiments, the content application is a sports content tracking application or other live event and/or on-demand content tracking application.

In some embodiments, the content user interface includes a plurality of event representations in a first category (e.g., events including sports games or other live events with corresponding video content available), the plurality of event representations consisting of at least a first event representation having information about a first event (e.g., user interface element 606a shown in FIG. 6A) and a second event representation having information about a second event (e.g., user interface element 606b shown in FIG. 6A) (702c). In some embodiments, live events are events that occurring in real time. In some embodiments, events within a category are organized by organizations (e.g., sports leagues, types of sports, and/or teams), and/or by time of event (e.g., events happening today, events that happened yesterday, and/or events that are happening in the future). For example, a first category is a category including a first league and the events within the category are related to the first league and are organized chronologically. Alternatively, a first category is a category including events happening today and the events within the category are organized chronologically. In some embodiments, information about the first event and information about the second event includes information relating to the organizations participating (e.g., organization colors, organization scores, and/or organization names), and/or information relating to the event (e.g., different events optionally have different information displayed on the representation of the event). For example, the organizations are sports teams and different types of sporting events optionally have different information displayed. In some embodiments, the first event is related to a first sporting type and the second event is related to a second sporting type. For example, the first event is a golfing event and the second event is a football event. Alternatively, in some embodiments, the first event and the second event are related to the same sporting type. For example, the first event and the second event are both soccer games.

In some embodiments, in accordance with a determination that an organization (e.g., a sports team, sports league, city, college, or other types of groups of people) associated with the first event is included in the list of organizations (e.g., favorited by the user) and an organization associated with the second event is not included in the list, the first event representation is displayed (702d) with higher priority than the second event representation in the content user interface. For example, user interface element 606a is displayed with a higher priority than user interface element 606b, shown in FIG. 6A. For example, user interface element 606e is displayed with a higher priority than user interface element 606f, as shown in FIG. 6B. For example, events where one or more of the associated organizations are in the list of organizations selected by the user have higher priority than events where none of the associated organizations are in the list. In some embodiments, displaying with higher priority includes displaying at the top of the plurality of event representations in a column or to the right of the plurality of event representations in a row. For example, the first event representation including one or more organizations included in the list selected by the user is listed before the second event representation (e.g., even if the second event associated with second event representation occurs before the first event associated with the first event representation).

In some embodiments, in accordance with a determination that the organization associated with the second event is included in the list and the organization associated with the first event is not included in the list, the second event representation is displayed (702e) with higher priority than the first event representation in the content user interface, such as if user interface element 606b was displayed with a higher priority than user interface element 606a, shown in FIG. 6A. In some embodiments, if the second event includes organizations included in the list, then the second event representation is displayed before the first event representation. In some embodiments, if a plurality of events in the first category includes organizations in the list, then the plurality of event representations are listed (prioritized) before other event representations that do not have organizations in the list. Additionally, in some embodiments, the plurality of event representations including organizations in the list are organized chronologically. In some embodiments, the plurality of event representations that do not have organizations in the list are also organized chronologically.

In some embodiments, while displaying the content user interface, the electronic device receives (702f), via the one or more input devices, an input to display a plurality of event representations in a second category different from the first category in the content user interface. In some embodiments, the input is a swipe input including a touchdown of a finger and a dragging motion of the finger to the left (e.g., right swipe) or to the right (e.g., left swipe). Alternatively, in some embodiments, the input is a selection input directed towards a selectable option. Alternatively, or additionally, in some embodiments, the input is a swipe gesture such as an air pinch gesture from a hand of a user of the electronic device including pinching (e.g., a thumb and index finger of the hand of the user coming together and touching), dragging (e.g., movement of the hand while the hand of the user is in a pinch hand shape), and/or releasing (e.g., the hand of the user de-pinching to cause the thumb and index finger to move apart). In some embodiments, the inputs described herein are any of the types of inputs described above.

In some embodiments, in response to receiving the input (702g), the electronic device ceases displaying (702h) the plurality of event representations in the first category and displays (702i), in the content user interface, a plurality of event representations in the second category such as displaying user interface elements 606e through 606h in FIG. 6B and no longer displaying user interface elements 606a through 606d in FIG. 6A. In some embodiments, the second category includes events that include organizations in the list of organizations. In some embodiments, the events that include organizations in the list are listed before the events that do not include organizations in the list. In some embodiments, the event representations (e.g., the event representations with organizations in the list and the event representations without organizations in the list) are listed chronologically. In some embodiments, the events in the second category have one or more of the characteristics of and/or or displayed with the one or more characteristics of the first and/or second events as described above. Prioritizing event representations that include organizations included in the list of organizations over event representations that do not include organizations in the list of organizations reduces erroneous or extra inputs to the electronic device to view the events including organizations in the list of organizations before other events.

In some embodiments, an organization in the list of designated organizations is a sports team, such as the sports teams shown by visual indications 622d and 622e in FIG. 6C. In some embodiments, a user selects a plurality of sports teams to be included in the list of organizations (e.g., the user favorites a plurality of sports teams). In some embodiments, the sports teams includes any sports team that is associated with a league (e.g., soccer, tennis, basketball, football, and/or baseball). In some embodiments, in response to favoriting a sports team, the electronic device displays event associated with that sports team with a higher priority than events without favorited sports teams. Including sports teams in the list of organizations allows additional customizability to the user's ability to favorite organizations, thereby reducing erroneous or extra inputs to the electronic device to view the events including organizations in the list of organizations before other events.

In some embodiments, an organization in the list of designated organizations is an association of sports teams, such as the leagues shown by visual indications 622a through 622c in FIG. 6C. In some embodiments, an association of sports teams is a league. For example, the NFL is an association of football teams, the NHL is an association of hockey teams, and the MLB is an association of baseball teams. In some embodiments, in response to favoriting (e.g., adding the association of sports teams to the list of organizations) an association of sports teams, the electronic device displays events associated with the favorited association of sports teams with a higher priority than events are not associated with favorited associations of sports leagues. Including sports leagues in the list of organizations allows additional customizability to the user's ability to favorite organizations, thereby reducing erroneous or extra inputs to the electronic device to view the events including organizations in the list of organizations before other events.

In some embodiments, the first category is associated with one of one or more first associations of teams in the list of organizations (e.g., the first category includes events associated with a league that has been favorited by the user) or one or more first teams in the list of organizations (e.g., the first category includes events associated with a first sports team that has been favorited by a user) and the second category is associated with another one, different from the first category, of the one or more first associations of teams in the list of organizations or the one or more first teams in the list of organizations. For example, the first category is associated with “My Teams”, shown in FIG. 6H, and the second category is associated with “My Leagues”, shown in FIG. 6I. In some embodiments, the first category is a first team and the second category is a second, different team. Alternatively, in some embodiments, the first category is a first league and the second category is a second league. Alternatively, in some embodiments, the first category is a first league and the second category is a first team. In some embodiments, the first and second categories are related to the same sport, or related to different sports. Alternatively, in some embodiments, the first category includes events associated with a first association of teams not included in the list of organizations, and/or the second category includes events associated with a second association of teams not included in the list of organizations. For example, the first category or the second category includes events for a league that has not been favorited. In some embodiments, the categories includes a category that includes events for a specific sport type. For example, baseball has two leagues that are optionally both included in a category. Including categories with events associated with favorited organizations and events associated with non-favorited organizations reduces erroneous or extra inputs to the electronic device to view different events corresponding to different categories.

In some embodiments, the plurality of event representations in the first category includes events on a first day (and optionally not on a second day) and the plurality of event representations in the second category includes events on a second day (and optionally not on the first day) different from the first day. For example, the first category is associated with “Today”, shown in FIG. 6A, and the second category is associated with “Tomorrow”, shown in FIG. 6B. In some embodiments, the electronic device sorts the events by past, present, and future (e.g., different days) instead of by different teams and/or leagues. In some embodiments, the electronic device sorts the events by a first day, a second day, and a third day (e.g., past, present, and future) and also by a team and/or league. In some embodiments, the events in the first category include events (e.g., in chronological order) from teams and/or leagues that have been favorited by a user before events (e.g., in chronological order) from teams and/or leagues that have not been favorited by a user (e.g., not in the list of organizations). In some embodiments, the electronic device has categories for −1 day from the current day through +6 days from the current day (e.g., 8 categories of different days). Sorting events by days that they occur allows the user to easily view different events, including events with favorited organizations and events without favorited organizations, thereby reducing erroneous inputs to the electronic device to view different events.

In some embodiments, while displaying the plurality of event representations in the second category (e.g., any of the categories as described above such as a future day, a sports league, and/or a sports type), the electronic device receives, via the one or more input devices, a second input, such as a swipe input with contact 658, shown in FIG. 6H. The second input has one or more characteristics of the input as described above. In some embodiments, the second input is a swipe input in the same direction as the input (e.g., right swipe, left swipe, up swipe, or down swipe).

In some embodiments, in response to receiving the second input the electronic device ceases displaying the plurality of event representations in the second category, such as if the user interface elements 654e through 654h were no longer displayed in FIG. 6I. For example, the electronic device no longer displays the event representations corresponding to a specific league, date, or Team.

In some embodiments, the electronic device displays, in the content user interface, a plurality of event representations in a third category, different from the first category and the second category, such as if user interface elements associated with “League 1” were displayed. In some embodiments, the categories are chronological. For example, if the second category includes event representations from +1 days from the present, then the third category includes representations from +2 days from the present. In some embodiments, if the second category includes leagues that are in the list of organizations (e.g., favorited leagues), then the third category includes a different league (or a different team) that is in the list of organizations or that is not in the list of organizations. In some embodiments, the first and second categories are different in a first characteristic, and the second and third categories are different in a second characteristic. Allowing a user to swipe through categories allows a user to easily view different events, including events with favorited organizations and events without favorited organizations, thereby reducing erroneous inputs to the electronic device to view different events.

In some embodiments, the plurality of event representations are chronologically ordered, such as shown by user interface elements 654f through 654h in FIG. 6I. In some embodiments, each category includes events that are ordered chronologically. In some embodiments, if the events in the category are associated with a favorited team and/or league, then they are displayed first and also in chronological order before the remaining events are displayed chronologically. In some embodiments, if the categories are organized by leagues and/or teams (e.g., as described above), then the events within are listed chronologically from −1 days from the present day to +6 days from the present day. In some embodiments, within each section for each day (e.g., −1 days from the present day to +6 days from the present day), the events are listed such that favorited events are listed first followed by other events for a given day. Chronologically ordering events in a category allows a user to quickly and efficiently identify when events are occurring, thereby reducing erroneous inputs to the electronic device.

In some embodiments, the plurality of event representations that includes events ordered chronologically that are not associated with the organizations in the list of designated organizations, such as shown by user interface elements 654f through 654h in FIG. 6I. In some embodiments, the events that are associated with the list of organizations occur after the events not associated with organizations in the list of designated organizations but they are displayed with higher priority (e.g., before, above, or to the left) compared to the events not associated with the organizations in the list of designated organizations are displayed. In some embodiments, the event representations are listed chronologically compared to each other (e.g., the favorited events are listed chronologically and then the other events are listed chronologically). Displaying events that include organizations in the list of designated organizations before events that do not include organizations in the list of designated organizations reduces erroneous or extra inputs to the electronic device to view the events including organizations in the list of organizations before other events.

In some embodiments, while displaying a first plurality of event representations in the first category, the electronic device receives, via the one or more input devices, a second input corresponding to a request to scroll (e.g., to scroll up or down the user interface) while displaying the content user interface, such as if FIG. 6H includes an input using a contact to swipe upward to scroll down.

In some embodiments, in response to receiving the second input, in accordance with a determination that the second input corresponds to a request to scroll in a first direction (vertically downward or horizontally to the left), the electronic device displays, in the content user interface, a second plurality of event representations that occur at a later time than the first plurality of event representations, such as if the electronic device displays events that occur after “Tomorrow” in response to receiving the input. In some embodiments, the second input has one or more characteristics of the input as described above. In some embodiments, the second input is a swipe input including a touchdown of a finger and a dragging motion of the finger left, right, up, or down. In some embodiments, the events are organized chronologically such that the events listed at the top of the content user interface (or at the left in the content user interface) occur earlier than the events listed at the bottom of the content user interface (or at the right in the content user interface).

In some embodiments, in response to receiving the second input, in accordance with a determination that the second input corresponds to a request to scroll in a direction opposite from the first direction (vertically upward or horizontally to the right), such as if FIG. 6H includes an input using a contact to swipe downward to scroll up, the electronic device displays, in the content user interface, a third plurality of event representations that occur at an earlier time than the first plurality of event representations, such as if the electronic device displays events that occur before “Today” in response to receiving the input. In some embodiments, in response to scrolling upward or to the right (e.g., such that the cards are moving to the right), the electronic device displays events that occur at an earlier time because the events are listed chronologically from earliest to latest. Chronologically ordering event representations in a category allows a user to quickly and efficiently identify when events are occurring, thereby reducing erroneous inputs to the electronic device.

In some embodiments, while displaying a first plurality of event representations in the first category, the electronic device receives, via the one or more input devices, a second input corresponding to a request to minimize the first plurality of event representations while in the content user interface, such as if the electronic device receives an input directed towards selectable option 656 in FIG. 6H. In some embodiments, the second input has one or more characteristics of the input as described above. In some embodiments, the second input includes a tap input (e.g., tapping a touch screen with a finger or an air-tap). In some embodiments, the second input is directed towards a selectable option that when selected, minimizes the first plurality of event representations.

In some embodiments, in response to receiving the second input, the electronic device ceases displaying the first plurality of event representations in the first category, such as if user interface elements 654a through 654b cease to be displayed in FIG. 6H. In some embodiments, the first category has one or more characteristics of the first category as described above. In some embodiments, the first plurality of event representations includes events from a specific organization that is in the list of organizations (e.g., events from a specific sports team/sports league). In some embodiments, the first plurality of event representations includes events on a specific day from organizations in the list of organizations. In some embodiments, the first plurality of event representations includes events from organizations not in the list of organizations. For example, the first plurality of event representations includes events associated with leagues not in the list of organizations (e.g., not favorited by the user) on a specific day.

In some embodiments, in response to receiving the second input, the electronic device displays a second representation of the first plurality of event representations in the first category, wherein the second representation is smaller in size than the first representation, such as if the electronic device displays a different user interface element, that is smaller in size than the user interface elements 654a through 654b in place of user interface elements 654a through 654b in FIG. 6H. In some embodiments, the second representation is a collapsed representation of the first plurality of events. In some embodiments, the second representation includes a display of the earliest occurring event in the first plurality of event representations while hiding the remainder of the events. In some embodiments, the second representation includes a selectable option, that when selected, redisplays the first plurality of event representations. In some embodiments, the second representation has less information than the first plurality of event representations. Alternatively, in some embodiments, the second representation has the same information as the first plurality of event representations. For example, the second representation is the first plurality of event representations displayed at a smaller size. Displaying event representations at a smaller size in response to an input allows the user to view additional event representations (e.g., collapsing the view of some event representations frees up screen real estate) thereby reducing erroneous inputs to the electronic device to view additional events.

In some embodiments, the content user interface further comprises a first selectable option that is selectable to display a user interface element including a subset of a list of categories (e.g., a drop down menu including a list of categories most relevant to the user), such as shown by menu 662 in FIG. 6J, and a second selectable option that is selectable to display a second user interface including a view of the list of categories including a representation of the first category and a representation of the second category (e.g., a selectable option in the drop down menu that, when selected, opens a user interface including a list of all the categories), such as shown by user interface 620 in FIG. 6C. In some embodiments, the user interface element includes representations of sports teams and leagues that are most relevant to the user (e.g., the sports teams and leagues that have been favorites and/or frequented by the user). In some embodiments, the teams and leagues that have more events associated with them are more relevant to the user. For example, the user interface element includes a representation of a league (e.g., NHL) in the winter while the NHL is actively playing games or a representation of the NCAA basketball league during March Madness. In some embodiments, the second user interface includes a view of the list of organizations (e.g., favorited leagues and teams). In some embodiments, the second user interface also includes a view of all the leagues and/or teams that are associated with events in the content user interface (e.g., including teams and/or leagues not in the list of organizations). Displaying a second user interface including a view of the list of categories allows a user to efficiently view the entire list of organizations, thereby reducing erroneous inputs to the electronic device.

In some embodiments, in accordance with a determination that the first category includes more events (within a respective time period) than the second category, the electronic device displays, on the user interface element, the representation of the first category before the representation of the second category in the list of categories, such as shown by “League 1” being displayed with higher priority than “League 2” in menu 662 in FIG. 6J. In some embodiments, the first category is more active than the second category when the first category has more events in a day (e.g., more events today), in a month, in a quarter, or in a year. In some embodiments, the number of events in a category optionally changes per day, per month, per quarter, or per year. In some embodiments, the order of the categories optionally changes as the number of events in a category changes. For example, the first category is listed before the second category today because the first category has more events than the second event today. Tomorrow, the first category is optionally listed after the second category because the second category has more events tomorrow than the first category. In some embodiments, the first category is associated with a league that is “in season” (e.g., NHL during hockey season, MLB during baseball season, or NFL during football season).

In some embodiments, in accordance with a determination that the second category includes more events (within the respective time period) than the first category, the electronic device displays, on the user interface element, the representation of the second category before the representation of the first category in the list of categories, such as if “League 2” is being displayed with higher priority than “League 1” in menu 662 in FIG. 6J. As described above, in some embodiments, a category with more events is a category that is more active. In some embodiments, the categories are listed by how frequently a user views the category. For example, a user is more interested in soccer than in football (e.g., the user favorites more soccer teams and/or leagues than football teams and/or leagues, or the user clicks on more (e.g., visits more) soccer associated events more than football associated events), therefore the categories associated with soccer leagues and/or teams are displayed before the categories associated with football leagues and/or teams. In some embodiments, the arrangement of categories in the list of categories on the user interface element corresponds to the arrangement of categories while the user swipes through the categories, as described above. Displaying the list of categories by how active the categories are allows the user to efficiently view categories with more events, thereby reducing erroneous inputs to the electronic device to view more active categories before less active categories.

In some embodiments, while displaying the second user interface including the view of the plurality of categories, the electronic device receives, via the one or more input devices, a second input directed towards the representation of the first category, such as if the electronic device detects an input directed towards indication 630h in FIG. 6D to add “League 5” to the list of organizations. In some embodiments, the second input has one or more characteristics of the input as described above. In some embodiments, the second input is a tap input, that has one or more characteristics of a tap input as described above. In some embodiments, the second input is directed towards a selectable option on or near the representation of the first category.

In some embodiments, in response to receiving the second input, the electronic device adds an organization associated with the first category to the list of organizations, such as if “League 5” was added to the list of organizations in FIG. 6D (e.g., indication 630h is shaded). In some embodiments, the user adds teams to a favorites list using the second user interface. In some embodiments, the second user interface includes an editing user interface that indicates which categories have organizations that are in the list of organizations and which do not. In some embodiments, adding an organization associated with the first category (e.g., a team associated with a league) to the list of organizations also includes displaying the organization in a list of organizations at the top of the second user interface before the electronic device displays the other organizations not in the list of organizations. In some embodiments, the user can rearrange the order of the organizations within the list of organizations. In some embodiments, the second user interface also includes a search bar to search for a particular category (e.g., search for a team, league, and/or sporting type). In some embodiments, the categories are individually selectable to view events associated with the categories in time chronological order (e.g., from event occurring the soonest to events occurring the latest). In some embodiments, the categories that are not associated with the list of organizations are prioritized by in-season sports (e.g., categories associated with organizations that are in season are displayed before categories that are associated organizations that are not in season (actively playing)). In some embodiments, the categories that are associated with the list of organizations (that are displayed separately from the other categories) are also prioritized by in-season sports. Adding an organization associated with a category to the list of organizations (e.g., favorites) in response to receiving an input directed towards a selectable option in the second user interface allows the user to favorite an organization without additional inputs, therefore reducing the number of inputs needed to favorite an organization.

In some embodiments, the second user interface includes a plurality of representations of the plurality of organizations associated with the plurality of categories, such as shown by indications 622d and 622e in FIG. 6D. the second user interface also displays teams of different sporting events.

In some embodiments, while displaying the second user interface including the plurality of representations of the plurality of organizations, the electronic device receives, via the one or more input devices, a second input directed towards a selectable option directed towards a representation of a first organization, such as if the electronic device detects an input directed towards indication 630f in FIG. 6D to add “Team 5” to the list of organizations. In some embodiments, the second input has one or more characteristics of the input as described above. In some embodiments, the second input is a tap input, that has one or more characteristics of a tap input as described above. In some embodiments, the second input is directed towards a selectable option on or near the representation of the first organization.

In some embodiments, in response to receiving the second input, the electronic device adds the first organization to the list of organizations, such as if “Team 5” was added to the list of organizations in FIG. 6D (e.g., indication 630f is shaded). In some embodiments, adding the first organization to the list of organizations includes displaying the first organization in the separate list in the second user interface. In some embodiments, the list includes teams and/or leagues, as described above. Adding an team to the list of organizations (e.g., favorites) in response to receiving an input directed towards a selectable option in the second user interface allows the user to favorite an organization without additional inputs, therefore reducing the number of inputs needed to favorite an organization.

In some embodiments, in accordance with the determination that the organization associated with the first event is included in the list of organizations selected by the user (e.g., the electronic device receives an input to add an organization to the list of organizations while in the second user interface, as described above), the electronic device displays an indication next to the organization on the first event representation, such as shown by indications 630a through 630e in FIG. 6D. In some embodiments, the indication includes icons and/or colors. For example, the electronic device displays a star icon next to the organization to indicate that the organization is on the list. Additionally, or alternatively, in some embodiments, the electronic device displays colors corresponding to the organization next to the organization on the first event representation. For example, the electronic device displays colors associated with a favorited team (e.g., team colors).

In some embodiments, in accordance with the determination that the organization associated with the first event is not included in the list of organizations selected by the user, the electronic device forgoes displaying the indication next to the organization, such as shown by the lack of shading on indications 630f through 620i in FIG. 6D. In some embodiments, the first event is associated with two organizations, a first organization on the list and a second organization not on the list. In some embodiments, the electronic device displays the indications described above for the first organization and forgoes displaying the indications for the second indication (e.g., the representation of the first event does not include colors associated with the second organization). Displaying an organization associated with the list of organizations with an additional indication allows a user to easily identify organizations in the list of organizations, therefore reducing erroneous inputs to the electronic device.

In some embodiments, the electronic device receives, via the one or more input devices, a second input directed towards the first event representation, such as shown by input using contact 634 in FIG. 6E. In some embodiments, the second input has one or more characteristics of the input as described above. In some embodiments, the second input is a tap input, that has one or more characteristics of a tap input as described above. In some embodiments, the second input is directed the first event representation (e.g., anywhere on the first representation).

In some embodiments, in response to receiving the second input, the electronic device displays a user interface corresponding to the first event that includes additional information about the first event not included in the information about the first event in the first event representation, such as shown by user interface 636 in FIG. 6F. In some embodiments, the user interface is as described in further detail in method 900. Displaying additional information corresponding to an event in response receiving an input to select the representation of the event allows the user to quickly view additional information, thereby reducing the inputs needed to view additional information.

In some embodiments, while displaying the content user interface, the electronic device receives, via the one or more input devices, a second input corresponding to a request to cease displaying the content user interface, such as if the electronic device 500 detects an input corresponding to closing the user interface 648 in FIG. 6I. In some embodiments, the second input has one or more characteristics of the input as described above. In some embodiments, the second input is a tap input, that has one or more characteristics of a tap input as described above. In some embodiments, the second input is a swipe input, that has one or more characteristics of a swipe input as described above. In some embodiments, before ceasing the display of the content user interface, the electronic device is displaying the categories in a first order.

In some embodiments, in response to receiving the second input, the electronic device ceases displaying the content user interface, such as if the electronic device 500 begins displaying a home screen user interface in FIG. 6I. In some embodiments, the electronic device displays a home screen user interface. In some embodiments, the home screen user interface serves as a “home base” for the device and had a plurality of icons associated with a plurality of applications. In some embodiments, in response to receiving the second input, the electronic device displays a different user interface of the content application. In some embodiments, in response to receiving the second input, the electronic device displays a user interface of a different application (e.g., such as in response to tapping a notification associated with another application or an input directed towards switching applications).

In some embodiments, after ceasing displaying the content user interface in response to receiving the second input, the electronic device receives, via the one or more input devices, a third input corresponding to a request to redisplay the content user interface, such as if the electronic device 500 detects an input to redisplay the user interface 648 in FIG. 6I. In some embodiments, the third input has one or more characteristics of the second input. In some embodiments, the request to redisplay the content user interface includes a request to cease the display of the user interface displayed which receiving the third input.

In some embodiments, in response to receiving the third input, the electronic device redisplays the content user interface. In some embodiments, in accordance with a determination that a first category of events has more relevance to the user than a second category of events based on one or more criteria, the electronic device displays the plurality of event representations in the first category with higher priority than a plurality of event representations in the second category, such as if the electronic device 500 redisplays the user interface elements 654a through 654d associated with “My Teams”, shown in FIG. 6H. In some embodiments, the one or more criteria includes criteria such as number of favorited organizations within the category, number of events in the category, and/or number of visits by the user to the category. In some embodiments, categories with more favorited organizations, more events, and/or more visits are more relevant to the user. For example, categories associated with a sporting type that is in season (e.g., hockey (and the leagues associated with hockey) in the winter) is more relevant than categories associated with sporting types that are not in season. In some embodiments, the electronic device displays the category that is most relevant to the user first, upon redisplaying the content user interface. In some embodiments, the categories are arranged by relevance such that a user swipes through categories from most relevant to least relevant based on the above criteria. In some embodiments, the most relevant category is presented at the most leftward position and less relevant categories are displayed rightward from there. In some embodiments, the electronic device displays the categories in a second order different than the first order that was displayed before the user interface was closed. In some embodiments, the second order is an updated order where the first category is listed before the second category because the first category is more relevant.

In some embodiments, in accordance with the determination that the first category of events does not have more relevance to the user than a second category of events based on one or more criteria, the electronic device forgoes displaying plurality of event representations in the first category with higher priority than a plurality of event representations in the second category, such as if the electronic device 500 redisplays the user interface elements associated with “League 1” because “League 1” is more relevant than “My Teams”. In some embodiments, the second category is displayed first after reopening the content user interface if the second category is more relevant than the first category to the user. In some embodiments, the second category is listed before the first category because the second category is more relevant. In some embodiments, the second category is displayed upon reopening of the content user interface irrespective of the portion of the user interface that was visible (e.g., the scrolling location) when the second input was received. Displaying a relevant category in response to closing and reopening the content user interface allows the user to quickly view a category more relevant to the user, thereby reducing the number of inputs needed to view a relevant category.

In some embodiments, the content user interface is associated with a first application (e.g., a first content application), such as a content application shown in FIG. 6A. In some embodiments, the electronic device shares the list of organizations selected by the user of the electronic device with a second application different from the first application, such as if the electronic device shares the list of organizations shown in FIG. 6C with a second application. In some embodiments, the favorited organizations remain favorited in different applications (e.g., a TV application, a news application, and/or other content/event applications). In some embodiments, changing the list of organizations (e.g., deleting, adding, and/or editing the list of organizations) results in the list of organizations in the second application to change as well. In some embodiments, the organizations in the list are prioritized in the second application. In some embodiments, changing the list of organizations in the second application results in the list of organizations in the first application to update, as well. For example, teams and/or organizations favorited in the second application are favorited in the first application so the events associated with those organizations are displayed with priority. Sharing the list of organizations with other applications reduces the number of inputs needed to create a list of organizations for other applications, thereby reducing erroneous and additional inputs to the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800 and 100) are also applicable in an analogous manner to method 700 described above with respect to FIG. 7. For example, the operation of displaying a content user interface with event representations described above with reference to method 700 optionally has one or more of the characteristics of displaying additional information about an event and displaying additional information about a play-by-play of an event including a representation of a current play described herein with reference to other methods described herein (e.g., methods 800 and 1000). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 702a, 702f, and 702g, and receiving operation 702e are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 8 illustrates a flow diagram illustrating a method in which an electronic device displays user interfaces including additional information about an event in response to an input in accordance with some embodiments of the disclosure. The method 800 is optionally performed at first electronic device and/or electronic devices such as device 100, device 300, or device 500 as described above with reference to FIGS. 1A-1B, 2-3, 4A-4B and 5A-5H. Some operations in method 800 are, optionally combined and/or order of some operations is, optionally, changed.

As described below, the method 800 provides ways in which an electronic device displays additional information about events using a user interface and ways in which an electronic device navigates between user interfaces including additional information about events. Swiping through user interfaces with additional information about events in priority and chronological order without having to return to the content user interface reducing the amount of erroneous inputs to the electronic device to see additional information about various events.

A method 800 is performed at an electronic device in communication with a display generation component and one or more input devices, such as electronic device 500 shown in FIG. 6A. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device displays (802a), via the display generation component, a content user interface including a first event representation having information about a first event and a second event representation having information about a second event, such as user interface elements 606a and 606b shown in FIG. 6A. In some embodiments, the content user interface includes one or more characteristics of the content user interface described in method 700. In some embodiments, the first event representation includes one or more characteristics of the first event representation as described in method 700. In some embodiments, the second event representation includes one or more characteristics of the second event representation as described in method 700.

In some embodiments, while displaying the content user interface, the electronic device receives (802b), via the one or more input devices, a first input to select the first event representation, such as with contact 634, shown in FIG. 6E. In some embodiments, the first input is a tap input. In some embodiments, a finger of the user performs the tap input. In some embodiments, the user uses a keyboard (e.g., touch keyboard or physical keyboard), a voice command, and/or a touchpad to perform the first input. In some embodiments, the first input includes an air pinch gesture from a hand of a user of the electronic device including pinching (e.g., a thumb and index finger of the hand of the user coming together and touching), dragging (e.g., movement of the hand while the hand of the user is in a pinch hand shape), and/or releasing (e.g., the hand of the user de-pinching to cause the thumb and index finger to move apart) directed to the first event representation. In some embodiments, the first input is one or more of the aforementioned types of inputs.

In some embodiments, in response to receiving the first input, the electronic device displays (802c) a user interface corresponding to the first event that includes additional information (e.g., as described below) about the first event not included in the first event representation, such as user interface 636 shown in FIG. 6F. In some embodiments, information about the first event displayed in the first event representation is also displayed in the user interface. In some embodiments, the user interface includes one or more selectable options that, when selected, causes the electronic device to display user interfaces of different content applications (e.g., a TV application as described below) capable of playing content corresponding to the first event. In some embodiments, the additional information includes additional information about the organizations participating in the event and other relevant information about the first event. In some embodiments, while displaying the user interface including additional information about the first event, the electronic device no longer displays the second event representation. In some embodiments, while displaying the user interface including additional information about the first event, the electronic device does not display information about the second event. In some embodiments, the user interface corresponding to the first event including additional information about the first event includes different and additional information from the first event representation.

In some embodiments, while displaying the user interface corresponding to the first event, the electronic device receives (802d), via the one or more input devices, a second input corresponding to a request to display a different user interface, such as with contact 640 in FIG. 6F. In some embodiments, the second input is a swipe input (.g., swiping up and down and/or right and left). In some embodiments, the second input has one or more characteristics of the swipe input described in method 700. In some embodiments, the second input is a tap and drag gesture and/or an air pinch and air drag gesture, as described above and in method 700.

In some embodiments, in response to receiving the second input (802e), the electronic device ceases displaying (802f) the user interface corresponding to the first event and displays (802g) a user interface corresponding to the second event that includes additional information about the second event not included in the second event representation, such as user interface 642 shown in FIG. 6G. In some embodiments, the second event is the event displayed after the first event while the electronic device is displaying the content user interface. For example, the second event occurs after the first event chronologically and/or the second event does not include organizations in the list of organizations (described in further detail in method 700) while the first event does. In some embodiments, if the second input is a right swipe or an up swipe, then the electronic device displays a user interface corresponding to the next event (e.g., a less prioritized event and/or an event occurring at a later time) in the list of event representations shown in the content user interface, described above. In some embodiments, if the second input is a left swipe or a down swipe, then the electronic device displays a user interface corresponding to the previous event in the list of event representations (e.g., a more prioritized event and/or an event occurring at an earlier time) shown in the content user interface, described above. The priority of events is described in greater detail in method 700. In some embodiments, the user interface corresponding to the second event has one or more characteristics of the user interface corresponding to the first event. In some embodiments, while displaying the user interface including additional information about the second event, the electronic device no longer displays the first event representation. In some embodiments, while displaying the user interface including additional information about the second event, the electronic device does not display information about the first event. In some embodiments, the user interface corresponding to the second event including additional information about the second event includes different and additional information from the second event representation of the second event. In some embodiments, the electronic device receives a third input corresponding to a swipe input while displaying the user interface corresponding to the second event. As a result, the electronic device optionally displays a user interface corresponding to a third event, different from the first and second events. In some embodiments, in response to repeated swipe inputs (e.g., repeated right swipe or repeated left swipes), the electronic device cycles through displaying user interfaces corresponding to the events in the first category, and then subsequently cycles through displaying user interfaces corresponding to the events in a second category, different from the first category. The first and second categories are described in greater detail in method 700. through user interfaces with additional information about events in priority and chronological order without having to return to the content user interface reducing the amount of erroneous inputs to the electronic device to see additional information about various events.

In some embodiments, the electronic device receives a list of organizations that have been designated by a user of the electronic device, wherein displaying the user interface corresponding to the second event (e.g., the user interface including additional information about the second event not included in the second event representation) in response to receiving the second input is based on selecting the second event according to a predefined order of events that prioritizes events associated with organizations included in a list of organizations selected by a user of the electronic device over events not associated with the organizations included in the list (e.g., the list of organizations is described in further detail in method 700), such as shown by the second event shown in user interface 642 (FIG. 6G (being the subsequent event from the first event shown by user interface 636 in FIG. 6F. For example, in the list of events shown in FIG. 6E, the second event corresponding to user interface 642 occurs after the first event corresponding to user interface 636. In some embodiments, in response to receiving inputs (e.g., swipe inputs similar to the second input), the electronic device displays user interfaces corresponding to the events shown on the content user interface in the same order as the events shown on the content user interface. For example, the content user interface orders the events such that events corresponding to favorited teams and/or leagues (e.g., organizations in the list of organizations) are displayed before events that don't correspond to favorited teams and/or leagues. As such, the electronic device displays content user interfaces corresponding to events that correspond to favorited teams and/or leagues before displaying user interfaces of events that don't correspond to favorited teams and/or leagues. Swiping through user interfaces with additional information about events in priority and chronological order without having to return to the content user interface reducing the amount of erroneous inputs to the electronic device to see additional information about various events.

In some embodiments, the predefined order of events includes events associated with organizations included in the list of organizations arranged in time chronological order (e.g., the events that will occur sooner are displayed before the events that will occur later) and then (e.g., followed by) the events not associated with the organizations included in the list arranged in time chronological order, such as shown by the order of user interface elements 654e through 654h in FIG. 6I. In some embodiments, the event representations in the content user interface are arranged in this predefined order wherein events associated with favorited teams and/or leagues are listed in chronological order and with higher priority than the events not associated with favorited teams and/or leagues, which are also arranged in chronological order. The prioritization of certain events is described in greater detail in method 700. Swiping through user interfaces with additional information about events in priority and chronological order without having to return to the content user interface reducing the amount of erroneous inputs to the electronic device to see additional information about various events.

In some embodiments, the first event and the second event are in a first category of events (e.g., events associated with a particular sporting league or with a certain day), the first category of events including one or more events associated with organizations included in the list of organizations and one or more events not associated with organizations included in the list of organizations, such as if the first event shown by user interface 636 in FIG. 6F and the second event shown by user interface 642 in FIG. 6G were the same sport and/or associated with the same league.

In some embodiments, while displaying the user interface corresponding to the second event (e.g., events associated with a different sporting league or a different day), the electronic device receives, via the one or more input devices, a third input corresponding to a request to display a different user interface, such as if the electronic device detects an input on user interface 642 in FIG. 6G. In some embodiments, the third input has one or more characteristics of the second input. In some embodiments, the third input is a swipe input including a swipe in the opposite direction of the second input. For example, the third input is a left swipe when the second input is a right swipe or the second input and the third input are both swipes in the same direction.

In some embodiments, in response to receiving the third input, the electronic device ceases displaying the user interface corresponding to the second event, such as if the electronic device no longer displays user interface 642 in FIG. 6G. In some embodiments, ceasing displaying the user interface corresponding to the second event includes ceasing displaying the additional information about the second event.

In some embodiments, in response to receiving the third input, the electronic device displays a user interface corresponding to a third event wherein the third event is in a second category of events different from the first category of events and including one or more events associated with organizations included in the list of organizations and one or more events not associated with organizations included in the list of organizations, such as if the electronic device displays a user interface associated with a third event (e.g., a third event that occurs on a different date). In some embodiments, the second event is the first event or the last event in the first category of events. In some embodiments, if the second event is the last event in the first category, then in response to a left swipe (e.g. a forward swipe), the electronic device displays the user interface corresponding to the third event. In some embodiments, if the second event is the first event in the first category, then in response to a right swipe (e.g., a back swipe), the electronic device displays the user interface corresponding to the third event or a user interface of a different event in a different category than the first category. In some embodiments, if the second event is not the last event in the first category, then in response to the third input, the electronic device displays a different user interface corresponding to a different event in the first category. Swiping through user interfaces through different categories consecutively without having to return to the content user interface reducing the amount of erroneous inputs to the electronic device to see additional information about various events.

In some embodiments, the first category of events includes events on a first day and does not include events on a second day different from the first day, and the second category of events includes events on the second day and does not include events on the first day, such as if the first event represented by user interface element 606a occurs today and the second event represented by user interface element 606b occurs tomorrow, shown in FIG. 6E. In some embodiments, categories range from −1 day from the present day to +6 days from the present day. In some embodiments, the first category of events and the second category of events are consecutive categories. For example, if the first event is happening on the present day, then the second event is either +1 days from the present events (e.g., for a left swipe) or −1 days from the present day events (e.g., for a right swipe). Swiping through user interfaces through different categories consecutively without having to return to the content user interface reducing the amount of erroneous inputs to the electronic device to see additional information about various events.

In some embodiments, the first category of events includes events including organizations in a first association of organizations and does not include events in a second association of organizations different than the first association of organizations, and the second category of events include events including organizations in the second association of organizations and does not include events including organizations in the first association of organizations, such as if the first event represented by user interface element 606a is associated with a first league and the second event represented by user interface element 606b is associated with a second league, shown in FIG. 6E. In some embodiments, the categories are different leagues of sports teams and/or a collection of leagues. For example, the categories include a category of the events associated with the teams in the list of organizations (e.g., favorited teams), and a category of the events associated with the leagues in the list of organizations (e.g., favorited leagues). In some embodiments, the categories also include a category of events associated with a specific league of sports or a specific team. In some embodiments, the first category of events is the first category in the user interface element including a subset of a list of categories, as described in method 700 and the second category of events is the second category in the user interface element including the subset of the list of categories. Swiping through user interfaces through different categories consecutively without having to return to the content user interface reducing the amount of erroneous inputs to the electronic device to see additional information about various events.

In some embodiments, the additional information of the first event includes additional information relevant to the organizations participating in the first event and the additional information of the second event includes additional information relevant to the organizations participating in the second event, such as the additional information shown in area 638 in FIG. 6F. In some embodiments, the additional information is relevant to the sport of the event. For example, if the first event is a soccer event, then the additional information includes relevant statistics about each player on each team for the soccer game and/or about each team for the soccer game. In some embodiments, different events for different sports have different information relevant to the sport. For example, golf statistics/data is different than basketball statistics/data. Displaying additional information relevant to the organizations participating in the event reduces the inputs needed to view additional relevant information.

In some embodiments, the first event is a first type of event and the second event is a second type of event, different than the first type of event, and the additional information of the first event is different than the additional information of the second event. For example, the information shown in area 638 in FIG. 6F is different than the information shown in area 638 in FIG. 6G. In some embodiments, the first event is an event for a first sport type and the second event is an event for a second sport type. As described above, each type of sport has different relevant information that is displayed (.g., different summary of games, betting odds, play-by-play, and/or lineup/box score). For example, the play-by-play information for a first sport is different than the play-by-play information for a second sport different from the first sport. For example, additional information for baseball optionally includes names of players on the different bases, the strikes and out numbers for the current player at bat, batting statistics, and/or other baseball specific data. Displaying additional information relevant to the organizations participating in the event reduces the inputs needed to view additional relevant information.

In some embodiments, in accordance with a determination that the first event is a live event that is currently happening or has already happened, the electronic device displays a selectable option in the user interface corresponding to the first event (e.g., the user interface with additional information about the first event) that is selectable to display a video of the first event, such as selectable option 644 in FIG. 6G. In some embodiments, in response to selecting the selectable option, the electronic device ceases displaying the user interface corresponding to the first event and begins displaying a user interface of a second application (e.g., a video streaming application or a television application). In some embodiments, the electronic device displays the video corresponding to the first event within the user interface of the content application (e.g., the present application).

In some embodiments, in accordance with a determination that the first event is not a live event that is currently happening or has already happened (e.g., the first event is upcoming), the electronic device forgoes displaying the selectable option, such as shown by user interface 636 in FIG. 6F not including selectable option 644 (because the event associated with user interface 636 is not a live event). In some embodiments, the electronic device displays a selectable option that is selectable to indicate to the second application to record the first event when it occurs for later viewing. In some embodiments, the electronic device displays a selectable option to remind the user to watch the first event when it occurs. In some embodiments, the video is displayed in the same user interface. Alternatively, In some embodiments, the video is displayed in a different user interface of the same application or of a different application. Initiating a second application to watch an event without having to return to a home screen (or other intermediate step) in response to detecting an input on a selectable option in the user interface reduces the amount of erroneous inputs to the electronic device.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 100) are also applicable in an analogous manner to method 800 described above with respect to FIG. 8. For example, the operation of displaying a content user interface with event representations described above with reference to method 800 optionally has one or more of the characteristics of displaying additional information about an event and displaying additional information about a play-by-play of an event including a representation of a current play described herein with reference to other methods described herein (e.g., methods 700 and 1000). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 8 are, optionally, implemented by components depicted in FIGS. 1A-1B. For example, displaying operation 802a, 802c, 802f, and 802g, and receiving operation 802d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces and Associated Processes

### Viewing a Representation of a Live Event

Users interact with electronic devices in many different manners. In some embodiments, an electronic device is connected to one or more input devices and one or more display generation component. In some situations, while viewing information about an event (e.g., while viewing information about a specific game), the electronic device displays a representation of the one or more events that have occurred and are presently occurring during the game. In some embodiments, the electronic device displays a representation of an object associated with the game and the movements of the respective object as they are occurring in real time. Displaying a visual representation of the object movement during a live event allows a user to better visualize the events occurring during the event thereby reducing the amount of erroneous inputs to the electronic device to see additional information about the event. It is understood that people use devices. When a person uses a device, that person is optionally referred to as a user of the device.

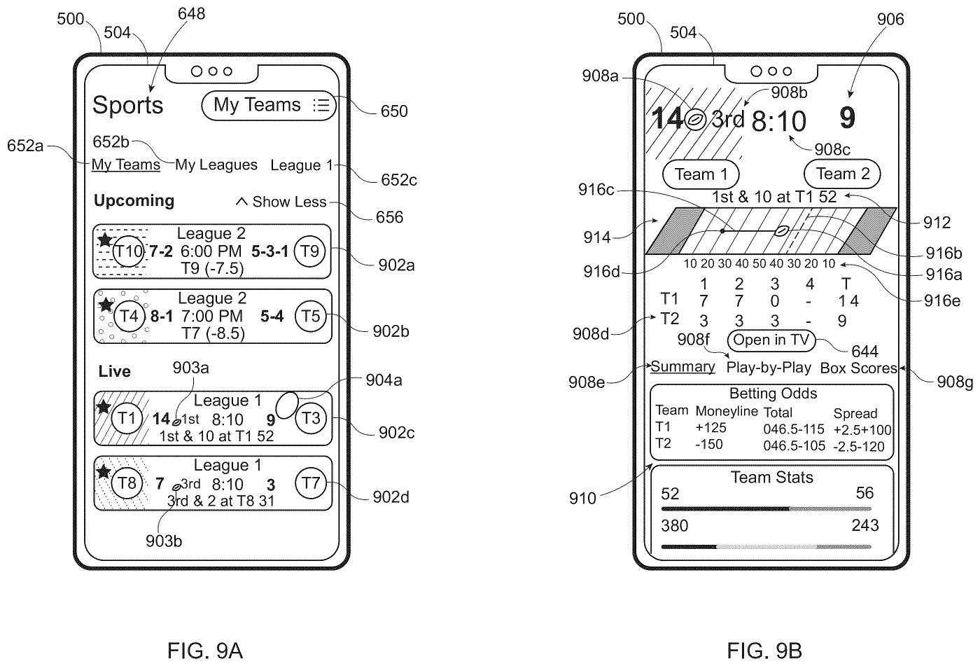

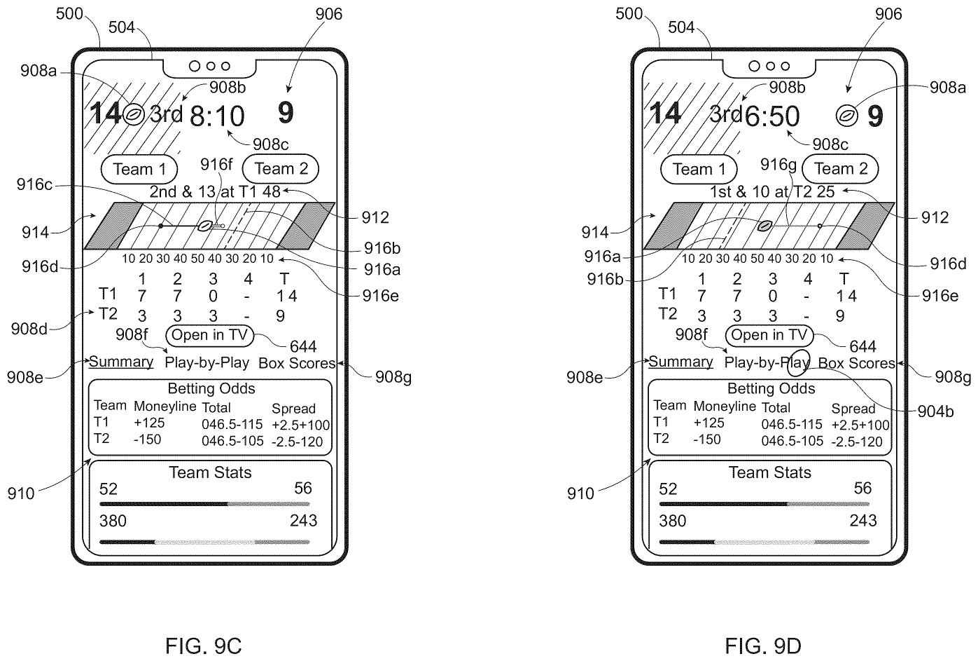

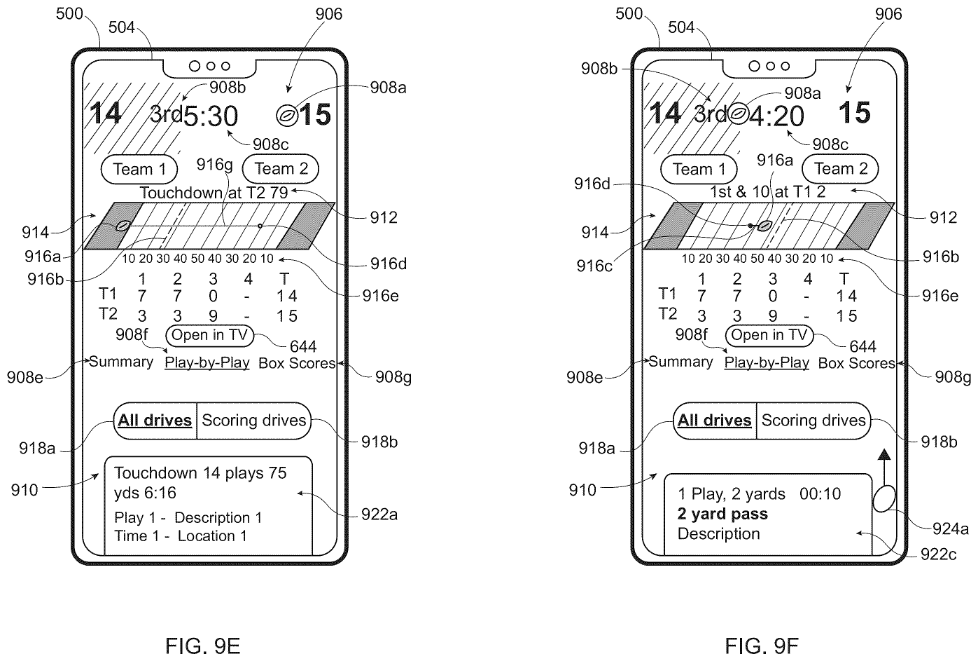

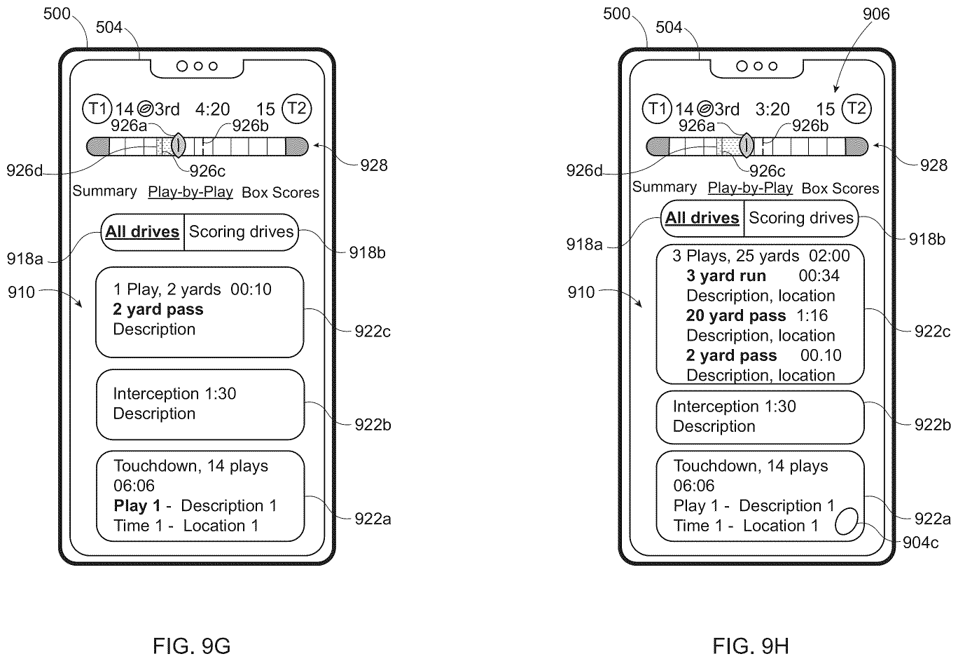

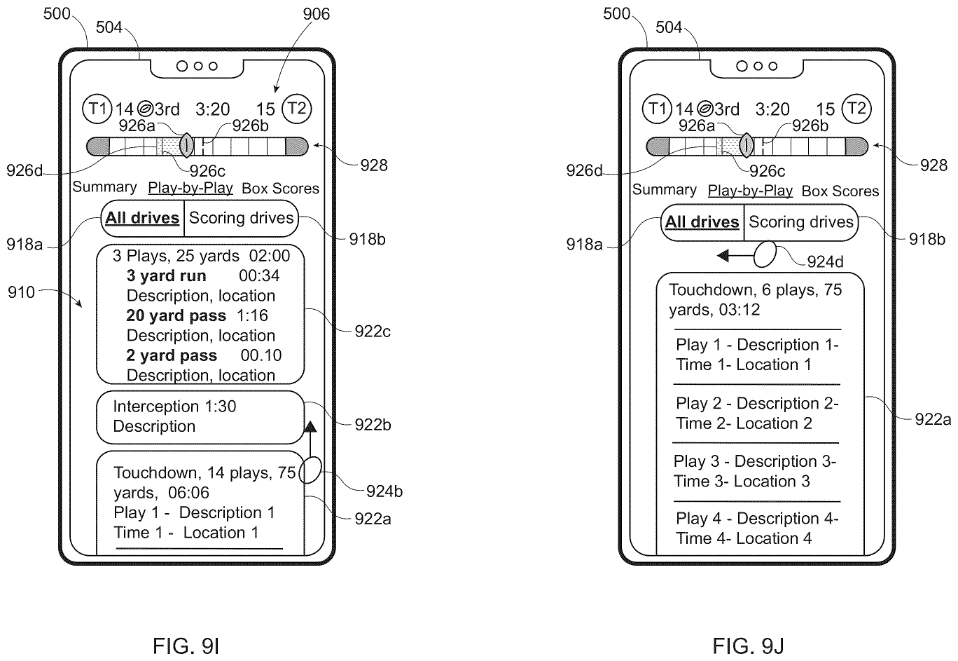

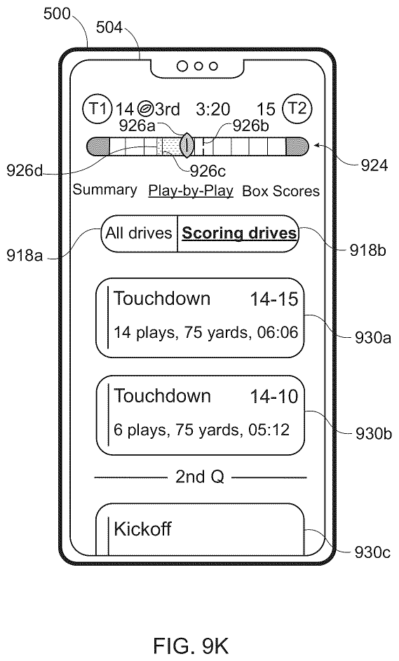

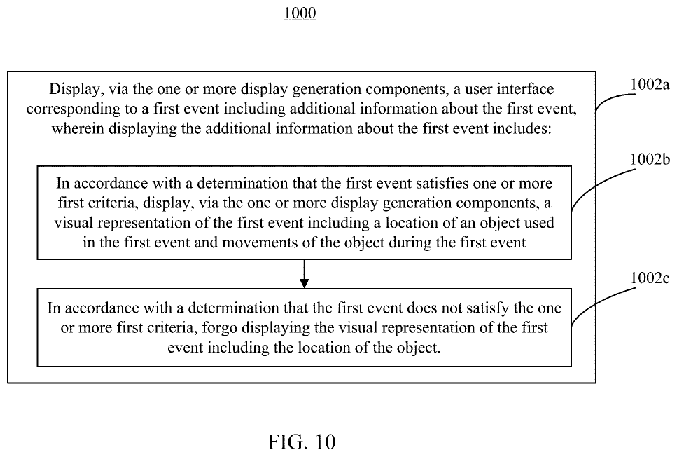

FIGS. 9A-9K illustrate exemplary ways in which an electronic device generates a representation of a live event that updates as the live event progresses. The embodiments in these figures are used to illustrate the processes described below, including the processes described with reference to FIG. 10. Although FIGS. 9A-9K illustrate various examples of ways an electronic device is able to perform the processes described below with respect to FIG. 10, it should be understood that these examples are not meant to be limiting, and the electronic device is able to perform one or more processes described below with reference to FIG. 10 in ways not expressly described with reference to FIGS. 9A-9K.

FIG. 9A illustrates an electronic device 500 with a display generation component 504. In some embodiments, the electronic device 500 is a mobile device, such as a smartphone, tablet, or wearable device. In some embodiments, electronic device 500 includes a content (e.g., playback, browsing, streaming, and/or sharing) application, such as described in greater detail above. In FIG. 9A, the electronic device 500 displays an embodiment of user interface 648, which is described in greater detail with reference to FIG. 6H. In FIG. 9A, the electronic device 500 displays user interface elements 902a through 920d. In some embodiments, the user interface elements 902a through 902d includes one or more characteristics of the user interface elements 606a through 606d and 654a through 654d. For example, user interface elements 902a through 902d includes a corresponding visual indication of teams participating in the event, a visual indication of the teams that are favorited by the user, a visual indication of the score of the event, and a visual indication of the time (e.g., when the event will occur, the time remaining on the event, or that the event has finished). However, the user interface elements 902a through 902d include additional visual indications not displayed in user interface elements 606a through 606d and 654a through 654d. For example, in FIG. 9A, user interface elements 902a through 902d include a corresponding visual indication of the league that the respective event is a part of (e.g., “League 1” and “League 2”). In FIG. 9A, user interface elements 902a and 902b correspond to events that are not currently live. In some embodiments, elements that correspond to events that are not currently live include a corresponding visual indication of betting odds (e.g., “T9 (−7.5)” and “T7 (−8.5)”). In FIG. 9A, user interface elements 902c and 902d correspond to events that are currently live. In some embodiments, live events are described in greater detail in methods 700, 800, and 1000. In some embodiments, elements (e.g., element 902c and 902d) that correspond to live events include a corresponding indication (e.g., indication 903a and 903b, respectively) that is placed near an indication of a team to indicate which team is in possession of the ball. For example, team “T1” is in possession of the ball in the event represented by element 902c, and team “T8” is in possession of the ball in the event represented by element 902d. Additionally, for live events, the electronic device 500 displays a corresponding text indication of the current location of the ball (e.g., “1^{st} & 10 at T1 52” and “3^{rd} & 2 at T8 31”) at the venue of the event (e.g., where the location of the ball is on the field of the live event).

In FIG. 9A, the electronic device 500 receives an input including contact 904a (e.g., a tap input using a finger) directed towards element 902c. In response to receiving the input in FIG. 9A, the electronic device 500 ceases displaying user interface 684 and begins displaying user interface 906, shown in FIG. 9B. In some embodiments, user interface 906 has one or more characteristics of expanded user interface 636 shown in FIG. 6F. For example, user interface 906, shown in FIG. 9B, includes additional relevant information about the event corresponding to element 902c such as indications of the teams playing in the event and the time remaining in the event (e.g., the information shown on user interface element 902c in FIG. 9A). In some embodiments, user interface 906 includes additional relevant information about the event, such as a summary of the teams' statistics for the current season, and other information that is specific to the event, the sport that the teams are playing, to the players of the teams (e.g., individual player statistics), and/or to the league that the teams are a part of.

FIG. 9B illustrates an expanded user interface 906 of an event involving team 1 and team 2 that is currently live (e.g., currently happening). User interface 906 includes a plurality of indications 908a through 908g including information about the event. In FIG. 9B, indication 908a includes an icon of an object used during the event (e.g., a football for a football game). The electronic device 500 displays indication 908a adjacent to the score (e.g. “14”) corresponding to team 1 to illustrate that team 1 currently is in possession of the object (e.g., the football). Indication 902b and 902c illustrates a time of the event. Specifically, indication 902b indicates what section the event is currently in (e.g., the third quarter, shown in FIG. 9B) and indication 902c indicates the time remaining in that section. In some embodiments, for different types of events, the electronic device 500 displays different sections and different times in accordance with the rules of the event (e.g., quarters of football games or soccer games, innings of baseball games). Additionally, in some embodiments, if the event has not occurred yet or has already occurred, the electronic device 500 does not display indication 902b and/or 902c, as shown in FIG. 6F. Indication 908d includes scores from team 1 (e.g., “T1”) and team 2 (e.g., “T2”) during the previous sections of the event (e.g., quarters 1, 2, and 3) and a total score, which is a combination of the scores from each section of the event. In some embodiments, the electronic device 500 updates indication 908d in response to either team scoring during the live event, as described below. The electronic device 500 also displays option 644, which is described in greater detail in FIG. 6G, because the event shown in user interface 906 is a live event. Indications 908e through 908f are tabs that when selected, causes the electronic device 500 to display corresponding additional information in area 910 about the event. In FIG. 9B, the electronic device 500 is displaying additional information in area 910 corresponding to the indication 908e, which is presently selected. In some embodiments, when the summary tab is selected, the electronic device 500 displays overview statistics such as betting odds, scoring statistics, team statistics, and other statistics about both teams. In some embodiments, the play-by-play tab includes information about the plays and drives that occurred and/or are currently occurring during the event. In some embodiments, the box scores tab includes information about the players in the teams, including statistics that are relevant to the type of event (e.g., football). In some embodiments, the tabs and information in area 910 correspond to the type of event that is being displayed. For example, the information shown for a football game is different than the information shown for a baseball game.

In FIG. 9B, the electronic device 500 displays text representation 912 and visual representation 914 of a current location of the ball and movements of the ball while the event shown in user interface 906 is a live event. In some embodiments, text representation 912 and visual representation 914 are described in greater detail in method 1000. Text representation 912 includes a text description describing the current portion of the event, a distance that the ball needs to travel to complete the play, which team is in possession of the ball, and a current location of the ball. Variations in the information included in text representation 912 are possible in some embodiments. Plays are described in greater detail in method 1000. Visual representation 914 includes a visual representation 916a of the ball at the current location of the ball, a visual representation 916d of the location of the ball at the start of the play, a visual representation 916c of the distance traveled by the ball during the play, a visual representation 916b of where the ball needs to be moved to complete the play on a representation of the venue of the event (e.g., a representation of the football field for a football game). The representation of the venue of the event is labeled with distance markers 916e and goal zones are highlighted in a different visual effect (e.g., the end zones are grey). In FIG. 9B, representation 916b through 916d are displayed with a first visual effect (e.g., a first color, a first line thickness, etc.) to indicate that Team 1 is in possession of the ball and players on team 1 are moving the ball. In some embodiments, representation 916b through 916d are displayed with a team 1 team color.

FIG. 9C illustrates user interface 906 with an updated visual representation 914 and textual representation 912 in response to a movement of the ball that occurred during the event (e.g., the game). For example, during the game, the ball moves backwards from where the ball needs to go for team 1 to complete the play, such as due to action(s) by team 2. In response to these actions that occurred during the game, the electronic device 500 updates visual representation 914 and textual representation 912 to reflect those actions. In FIG. 9C, the electronic device 500 displays visual representation 914 with visual representation 916f to indicate that the ball (e.g., visual representation 916a) has moved backwards from where the ball needs to go (e.g., towards representation 916b) for team 1 to complete the play. The electronic device 500 displays representation 916f with a second visual effect (e.g., a second color, second line thickness, etc.) to indicate the previous location of the ball that was closer to the location the ball needs to go for team 1 to complete the play than the current location of the ball is. Additionally, in response to receiving an indication of the movement of the ball, the electronic device 500 updates textual representation 912 to a text description describing the current portion of the event (e.g., which down team 1 is at), a distance that the ball needs to travel to complete the play, which team is in possession of the ball, and a current location of the ball.

FIG. 9D illustrates the user interface 906 with an updated visual representation 914 and textual representation 912 in response to team 2 having possession of the ball and moving the ball. In FIG. 9D, the electronic device 500 updates textual representation 912 to indicate the new current portion of the event (e.g., “1^{st} & 10”), the new distance that the ball needs to travel to complete the play (e.g., “25”), that team 2 is in possession of the ball, and to indicate the new current location of the ball. In FIG. 9D, the electronic device 500 displays visual representation 916g, which illustrates the movement of the ball from the starting location (e.g., visual indication 916d) to the current location of the ball (e.g., visual indication 916a). In some embodiments, visual representation 916g is displayed when team 2 has possession of the ball and representation 916c is displayed when team 1 has possession of the ball. In FIG. 9D, the electronic device 500 displays representation 916a, 916d and 916g with a third visual effect (e.g., a third color, third line thickness, etc.). In some embodiments, the electronic device 500 displays representations 916a, 916d and 916g with a color associated with team 2. Additionally, in FIG. 9D, because team 2 has possession of the ball, the electronic device 500 updates the location of 908a to be adjacent to the score of team 2.

In FIG. 9D, the electronic device 500 receives an input including contact 904b directed towards indication 908f. In response to receiving the input in FIG. 9D, the electronic device 500 displays information corresponding to play-by-play information in area 910, shown in FIG. 9E. Additionally, FIG. 9E illustrates the electronic device 500 displaying an updated representation 912 and 914 in response to receiving an indication (e.g., via network connection) that team 2 scored a touchdown in the live event.

FIG. 9E illustrates user interface 906 including information about the play by play of the event. In response to receiving the input in FIG. 9D, the electronic device 500 displays options 918a and 918b in FIG. 9E. In FIG. 9E, option 918a is selected and therefore, bolded. In some embodiments, other visual indications of which of options 918a and 918b is selected are possible, such as colors, textures, opacity, sizes, and/or displaying an additional image. In some embodiments, option 918a, when selected, causes the electronic device 500 to display all drives of the event. In some embodiments, all drives include scoring and additional drives, as described in method 1000. In some embodiments, option 918b, when selected, causes the electronic device 500 to display scoring drives of the events without the additional drives, as described in method 1000. In FIG. 9E, the electronic device 500 displays indication 922a as the first indication to be displayed in the “all drives” category, because indication 922a includes a description of the most recent drive (e.g., the touchdown that is also displayed on representation 912 and 914). Indication 922a is also displayed in the scoring drives category since the touchdown is also a scoring drive. Indication 922a includes a summary of the drive including a text description of the most recent drive, the number of plays during the drive, the distance traveled during the drive, the time elapsed during the drive. Indication 922a also includes information about each play during the drive. For example, in FIG. 9E, the electronic device 500 displays information about “play 1”, the most recently occurring play in the drive in indication 922a. In some embodiments, information of the respective plays includes a title, description (e.g., which players were participating in the play and what actions they took during the play), a location on the venue (e.g., the location on the field) that the play occurred, and an elapsed time of the play.

In FIG. 9E, the electronic device 500 updates representation 912 and 914 to illustrate the touchdown from the live event. The electronic device 500 updates the current location of the ball (e.g., representation 916a) and the distance traveled by the ball (e.g., representation 916g). Additionally, the electronic device 500 updates the score corresponding to the second team (e.g., from 9 to 15) because of the touchdown.

After team 2 scores the touchdown, team 1 regains possession of the ball and starts a new drive. In FIG. 9F, the electronic device 500 updates indication 908a to be adjacent to the score associated with team 1, since team 1 has possession of the ball in the live event. In FIG. 9F, the electronic device 500 updates representations 912 and 914 to illustrate the current drive and/or play that is occurring during the live event. In FIG. 9F, the electronic device 500 updates representation 914 by updating the location of the ball (e.g., representation 916a), the location which the ball needs to move to (e.g., representation 916b), the distance moved by the ball (e.g., representation 916c), and the starting location of the ball during the drive (e.g., representation 916d). Additionally, the electronic device 500 displays one or more of the representations 916a through 916d with the first visual effect because the first team (e.g., team 1) is in possession of the ball. In FIG. 9F, the electronic device 500 updates the area 910 to include an indication 922c of the newest drive. As described in method 1000, most recently occurring drives are displayed with higher priority than previously occurring drives. Indication 922c has one or more characteristics of 922a. In FIG. 9F, the electronic device 500 displays indication 922c including a summary of the drive (e.g., number of plays, distance traveled, elapsed time) and then a description of the individual plays in the drive (e.g., name and description of the play). In some embodiments, the electronic device 500 does not display an indication corresponding to the drive of indication 922c because the drive is ongoing and does not include a scoring event. In some embodiments, if the drive progresses to include an increase in score (e.g., the first team scoring), then the electronic device 500 would add an indication of the drive to the scoring drives category.

In FIG. 9F, the electronic device detects a swipe input including contact 924a directed towards user interface 906. In some embodiments, the swipe input is an input to scroll on the user interface 906 so that electronic device 500 displays additional information about the drives and plays. In response to detecting the input in FIG. 9F, the electronic device 500 displays additional drive and play information on user interface 906 by using a larger portion of the touch screen to display drive and play information, shown in FIG. 9G.

In FIG. 9G, the electronic device 500 updates user interface 906 in response to the scroll input in FIG. 9F. In FIG. 9G, the electronic device 500 condenses the information displayed above the area 910. For example, the electronic device 500 abbreviate the team names from “Team 1” and “Team 2” to “T1” and “T2” ceases displaying representations 912 and 914 and displays representation 928. In some embodiments, representation 928 is a condensed version of representation 912. Rather than displaying the field of the event as a planar representation (e.g., representation 912), the electronic device 500 displays the field of the event as a linear representation (e.g., representation 928), as shown in FIG. 9G and described in further detail below with reference to method 1000. Representation 928 contains one or more of the components (e.g., the representations) of representation 912. For example, representation 928 includes a representation 926a of the current location of the ball, a representation 926b of the location that the ball needs to travel to, a representation 926c of the movement of the ball, and a representation 926d of the starting location of the ball. In FIG. 9G, the representation 928 corresponds to the representation 914, shown in FIG. 9F. Additionally, the electronic device 500 displays indications 922a through 922c in response to the input in FIG. 9F. Because representation 928 is a smaller size than representation 912 and 914, the electronic device 500 has more screen real estate to display additional indications of drives that have occurred during the event. Indication 922c corresponds to the current/most recent drive (e.g., the third drive), and indications 922b and 922c are previous drives in chronological order (e.g., the second drive and the first drive, respectively), as described in greater detail in method 1000. In some embodiments, if the event displayed with user interface 906 is a previously live event (e.g., already occurred), then the electronic device 500 still displays the indications of all drives and scoring drives in chronological order as described in method 1000.

In FIG. 9H, the electronic device 500 updates representation 928 and adds text corresponding to additional plays to indication 922c as the current drive progresses during the live event. Because indication 922c corresponds to the current drive, the electronic device 500 displays indication 922c with the plays corresponding to the drive (e.g., 3 yard run, 20 yard pass, and 2 yard pass). Indications 922b and 922a correspond to previous drives, therefore the electronic device 500 does not display information about the respective plays.

In FIG. 9H, the electronic device 500 detects an input including contact 904c directed towards indication 922a. In response to detecting the input in FIG. 9H, the electronic device 500 updates the display of indication 922a to include information about the respective plays of the first drive, as shown in FIG. 9I. In some embodiments, information of the respective plays includes a title, description (e.g., which players were participating in the play and what actions they took during the play), a location on the venue (e.g., the location on the field) that the play occurred, and an elapsed time of the play.

In FIG. 9I, the electronic device 500 detects a scroll input including contact 924b, directed towards user interface 906 to scroll down to view additional plays and drives. In response to detecting the scroll input in FIG. 9I, the electronic device 500 displays additional plays and drives of the first drive, shown in FIG. 9J. In some embodiments, if the electronic device 500 receives a second scroll input to scroll down in FIG. 9J, the electronic device 500 will display additional drives that have occurred during the event. In some embodiments, if the electronic device 500 receives a second scroll input in FIG. 9J to scroll up, then the electronic device 500 would display more recently occurring drives, such as shown in FIG. 9I.

In FIG. 9J, the electronic device 500 detects a leftward swipe input including contact 924d directed towards user interface 906. In response to receiving the input in FIG. 9J, the electronic device 500 updates user interface 906 to display information corresponding to scoring drives in area 910, shown in FIG. 9K. In some embodiments, the electronic device 500 detects a selection input directed towards option 918b, which causes the electronic device 500 to update user interface 906 to display information corresponding to scoring drives in area 910, shown in FIG. 9K.

In FIG. 9K, the electronic device 500 displays indications 930a through 930c, corresponding to the scoring drives of the event in chronological order such that the most recently occurring scoring drive is displayed first (e.g., indication 930a) and previously occurring scoring drives are displayed after, without displaying additional drives. In some embodiments, scoring drives are described in greater detail in method 1000. Indications 930a through 930c include a corresponding name for the respective scoring drive, the distance traveled during the respective scoring drive, the elapsed time during the respective scoring drive, and the score of both organizations after the respective scoring drive. In some embodiments, in response to receiving a selection input directed towards a respective indication 930a through 930c, the electronic device 500 displays the one or more plays that correspond to the respective scoring drive.

FIG. 10 is a flow diagram illustrating a method in which an electronic device generates a representation of a live event that updates as the live event progresses in accordance with some embodiments of the disclosure. The method 1000 is optionally performed at first electronic device and/or electronic devices such as device 100, device 300, or device 500 as described above with reference to FIGS. 1A-1B, 2-3, 4A-4B and 5A-5H. Some operations in method 1000 are, optionally combined and/or order of some operations is, optionally, changed.

As described below, the method 1000 provides ways in which a flow diagram illustrating a method in which an electronic device generates a representation of a live event that updates as the live event progresses. Displaying a visual representation of the object movement only during a live event reduces the amount of erroneous inputs to the electronic device to see additional information about events that are not live.

Method 1000 is performed at an electronic device in communication with one or more display generation components and one or more input devices. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device (e.g., electronic device 500, shown in FIG. 9A) displays (1002a), via the one or more display generation components, a user interface corresponding to a first event (e.g., having one or more characteristics of the first event described in method 700 and/or 900) including additional information about the first event (e.g., the user interface including additional information about the first event has one or more characteristics of the user interface including additional information about the first event described in method 900), such as user interface 906, shown in FIG. 9A.

In some embodiments, in accordance with a determination that the first event satisfies one or more first criteria (e.g., such as a criterion that is satisfied when the first event is a ball or ball-based game such as soccer, baseball, football, basketball, hockey, or similar ball games, and/or a criterion that is satisfied when the first event is a live event. Live events are described in greater detail in methods 700 and 900.), the electronic device displays (1002b), via the one or more display generation components, a visual representation of the first event including a location of an object (e.g., ball or puck) used in the event and movements of the object during the event (e.g., movements of the object between different people of the organizations associated with the event, such as teams, as described in greater detail in method 700), such as representation 916a, shown in FIG. 9B. In some embodiments, the user interface includes a first portion of the user interface including information about the first organization participating in the first event (e.g., scores, organization name, organization colors, or other information) and a second portion of the user interface including information about the second organization participating in the second event (e.g., scores, organization name, organization colors, or other information). In some embodiments, the representation of the first event includes a representation of the location (e.g., the venue of the event), field, or bounds of the event (e.g., football field, soccer field, baseball field, hockey arena, golf course, or other game locations). In some embodiments, the representation of the location of the event includes a first side associated with the first organization and a second side associated with the second organization. In some embodiments, the first side is in the first portion of the user interface and the second side is in the second portion of the user interface. In some embodiments, the electronic device displays the movements of the object during the event, such as the movement of the ball during the current play of the event (e.g., the current play starts when a referee sounds a whistle for a play to start and ends when a team scores or when an opposing team gets the object (e.g., the ball)). In some embodiments, displaying the movement of the object includes displaying a previous and current location of the object on (e.g., overlaid on) the representation of the location of the event (e.g., the venue of the event). In some embodiments, displaying the movement of the object includes displaying the movement of the object relative to the location, field, and/or bounds of the event. In some embodiments, the object is displayed in the respective side of the user interface and/or representation of the location, field and/or bounds corresponding to the respective team currently with the object. In some embodiments, the location of the object that is overlaid on the representation of the location of the event corresponds to a real time location and/or a previous real time location of the object on the actual location of the event (e.g., the location of the ball on the actual field). Additionally, in some embodiments, the location of the object does not correlate to the portion of the user interface that a respective organization is associated with. For example, the object is associated with a first organization and is shown at multiple different locations on the user interface based on the movement and/or the current location of the object. For example, the object displayed at a specific location is able to be associated with the first organization or the second organization depending on the status of the event (e.g., which organization has possession of the object).

In some embodiments, in accordance with a determination that the first event does not satisfy the one or more first criteria, the electronic device forgoes displaying (1002c) the visual representation of the first event including the location of the object, such as if the electronic device 500 was displaying a user interface of an event that is not currently live in FIG. 9B. In some embodiments, the one or more criteria is not satisfied when the first event is a sport other than a type of sport that satisfies the one or more first criteria. In some embodiments, the first event is not a live event (e.g., the first event was a past event or is a future event that has not occurred yet), and thus the one or more first criteria are not satisfied. Displaying a visual representation of the object's movement during a live event allows a user to better visualize the events occurring during the event thereby reducing the amount of erroneous inputs to the electronic device to see additional information about the event.

In some embodiments, the one or more first criteria include a criterion that is satisfied when the first event is a live event, such as the event shown in FIG. 9B. In some embodiments, live events are events that occur in real time, as described in methods 700 and 900. In some embodiments, if the first event is not a live event, then the electronic device forgoes displaying the visual representation of the first event including the location of the object. Displaying a visual representation of the object movement only during a live event reduces the amount of erroneous inputs to the electronic device to see additional information about events that are not live.

In some embodiments, the electronic device displays, via the display generation component, a second content user interface including a plurality of event representations, the plurality of event representations including a first event representation having information about the first event, such as indications 902a through 902d displays on user interface 648, shown in FIG. 9A. In some embodiments, the second content user interface has one or more characteristics of the content user interface described in method 700. In some embodiments, the plurality of event representations has one or more characteristics of the event representations described in method 700 and shown in FIGS. 6A and 6I. In some embodiments, the second content user interface includes a plurality of event representations organized by categories (e.g., organization categories such as sports leagues, types of sports, and/or teams) and by when the event is happening. In some embodiments, the electronic device displays the second content user interface in response to detecting an input corresponding to a request to minimize, exit and/or collapse the user interface corresponding to the first event. In some embodiments, while displaying the second user interface including the first event representation, the electronic device receives an input to select the first event representation and in response to receiving the input, the electronic device ceases displaying the second user interface and displays the user interface corresponding to the first event. In some embodiments, in response to detecting an input to select an event representation, the electronic device displays the user interface corresponding to the respective event representation.

In some embodiments, the information about the first event in the second content user interface includes less information than the additional information about the first event displayed in the content user interface, such as the information displayed in indication 902c, shown in FIG. 9A, is less information than the information displayed by user interface 906, shown in FIG. 9B In some embodiments, and as described in greater detail in method 700, the information about the first event includes information corresponding to the organizations participating in the first event, such as organization colors, organization scores, and/or organization names. In some embodiments, the information about the first event includes information relating to the event. In some embodiments, the information about the first event includes overview information. Optionally, the additional information includes other information about the event described herein.

In some embodiments, in accordance with a determination that the first event satisfies the first one or more criteria, displaying an indication including information about a current play on the first event representation, such as displaying indication 903a on indication 902c to indicate which team currently has possession of the ball, shown in FIG. 9A. In some embodiments, information about the current play includes information about the current location of the object, information about the possession of the object, or other information corresponding to the additional information in the user interface corresponding to the first event. In some embodiments, the information about the current play is also displayed and/or accessible from the user interface corresponding to the first event. In some embodiments, the electronic device displays an indication of the object user in the event (e.g., a visual or textual representation such as an icon of the object such as a football, soccer ball, baseball, basketball, or other object used in the event). In some embodiments, the electronic device displays the indication of the object adjacent to, near, and/or in proximity to the portion of the event representation corresponding to the organization that is in possession of the object. For example, if team 1 has the football, the electronic device displays an indication of the football next to text and/or images corresponding to team 1 (e.g., next to a score corresponding to team 1). Displaying an indication of the object on the first event representation if the event is live reduces the amount of inputs needed to view which organization is in possession of the ball, thereby reducing erroneous inputs to the electronic device.

In some embodiments, the additional information about the first event includes an overview list including an overview of a first scoring drive and an overview of a second scoring drive (e.g., the overview list includes an overview of one or more scoring drives that occurs/occurred/will occur during the duration of first event), such as the indications 930a through 930b representing the overview list, shown in FIG. 9K.

In some embodiments, the electronic device displays the overview of the first scoring drive with higher priority in the overview list than the overview of the second scoring drive, wherein the first scoring drive occurs after the second scoring drive, such as indication 930a being displayed before indication 930b, shown in FIG. 9K, because the scoring drive of indication 930a occurs after (in time) the soring drive of indication 930b. In some embodiments, displaying with higher priority includes displaying at the top of the list of scoring drives in a column or to the right of the plurality of scoring drives in a row. In some embodiments, the first scoring drive is a more recent scoring drive than the second scoring drive, therefore it is displayed with higher priority. In some embodiments, in a given event, the event has one or more drives that results in 1. either an increase in score or 2. a change in possession of the object of the event. In some embodiments, the scoring drives list includes overviews of the one or more drives that results in an increase in score for a respective organization without including overviews of one or more drives that do not result in an increase in score. In some embodiments, a scoring drive is a continuous set of plays that ends with the offensive team (e.g., the team in possession of the object) scoring points. In some embodiments, the overview of the scoring drive includes information from one or more or all of the plays that occur within the scoring drive. In some embodiments, the overview of the scoring drive includes a subset of the information that is displayed about the scoring drive in response to receiving an input to display an expanded view of the scoring drive, as described below. In some embodiments, some events do not include drives or plays (described in greater detail below), and for such events, the electronic device applies one or more techniques described herein that apply to the event without displaying a view that includes scoring drives and/or additional drives. Displaying the overview list including the scoring drives in chronological order allows a user to efficiently view scoring drives thereby reducing erroneous inputs to the electronic device.

In some embodiments, the overview of a respective scoring drive includes a title of the respective scoring drive, a description of the respective scoring drive, and a time (and/or duration) of the respective scoring drive, such as shown by the information in the respective indications (e.g., indications 930a through 930d), shown in FIG. 9K. In some embodiments, the title of the scoring drive is the type of scoring drive (e.g., a touchdown, a kick off, a penalty throw, a penalty kick, a homerun, or other types of drives that result in an increase in a score). In some embodiments, the description of the scoring drive includes information about the sequence of plays in the drive. In some embodiments, the plays in a drive are the sequence of events to occur during the scoring drive (e.g., movements of the object to cause a scoring drive or downs). In some embodiments, the time is the total amount of time of the scoring drive (e.g., the amount of time for the respective organization to start and finish the scoring drive). Displaying the title, description, and time of a respective scoring drive reduces the number of inputs needed to view information relating to the respective scoring drive, thereby reducing erroneous inputs to the electronic device.

In some embodiments, while displaying the overview of the first scoring drive, the electronic device detects, via the one or more input devices, an input directed towards the overview of the first scoring drive, such as if the electronic device 500 detects a tap input directed towards indication 930a, shown in FIG. 9K. In some embodiments, the input is a selection input such as a direct input (e.g., tap with a finger, a gaze, or a voice input), or an indirect input (e.g., a click with a mouse or a tap with a stylus) directed towards the overview of the first scoring drive (e.g., or directed towards a selectable option).

In some embodiments, in response to detecting the input, the electronic device displays an expanded view of the first scoring drive including a sequence of plays that satisfies one or more sequence criteria, such as if the electronic device 500 displays indication 922a, shown in FIG. 9J, in place of indication 930a shown in FIG. 9K. In some embodiments, the expanded view of the first scoring includes information about the sequence of plays of the first scoring drive, such as the description, time, and location of the plays of the sequence of plays not included in the overview of the drive. In some embodiments, the sequence criteria are satisfied when the one or more plays are consecutive plays and the first play starts at the beginning of the scoring drive and the last play of the sequence of plays is the last play of the scoring drive. Displaying details (e.g., the sequence of plays) of the first scoring drive in response to receiving an input directed towards the first scoring drive allows the user to efficiently view additional information about the first scoring drive without multiple inputs thereby reducing erroneous inputs to the electronic device.

In some embodiments, the additional information about the first event includes a drive list (e.g., a list of drives including scoring and non-scoring drives, described in greater detail above) including an indication of a first drive included in the first event and an indication of a second drive included in the first event, such as the indications 922a through 922c, shown in FIG. 9G. In some embodiments, the electronic device displays the drives (e.g., the first drive and the second drive) in the drive list as overviews. For example, the electronic device displays a respective summary for the respective drive. In some embodiments, the indications of respective drives are expandable such that the electronic device displays the sequence of plays for the respective drive. Displaying all drives included in the first event allows the user to view different drives in one place, thereby reducing erroneous inputs to the electronic device.

In some embodiments, displaying the indication of the first drive includes displaying a play list including an indication of a first play and a second play (e.g., the play list includes a list of plays that, together, create the drive), such as indication 922c shown in FIG. 9I.

In some embodiments, in accordance with a determination that the first play occurred after the second play, the electronic device displays the indication of the first play with higher priority than the indication of the second play in the play list, such as the first play titled “3 yard run” occurring after (in time) the second play titled “20 yard pass”, and therefore being displayed with higher priority, as shown in FIG. 9I. In some embodiments, plays that are currently happening/most recently occurred are displayed before previously occurring plays. In some embodiments, the plays are displayed in chronological order such that the currently occurring play is displayed first and then the previous plays are displayed after. In some embodiments, the event is completed and no longer live, and the electronic device displays the list of drives and the list of plays within the respective drive in chronological order such that the most recently completed drive (e.g., the last drive) and the most recently complete respective play is displayed first/with higher priority and that the earliest completed drive (e.g., the first drive) and the earliest completed play is displayed last.

In some embodiments, in accordance with a determination that the second play occurred before the first play, the electronic device displays the indication of the second play with higher priority than the indication of the first play in the play list, such as if such as the first play titled “3 yard run” shown in FIG. 9I occurs before (in time) the second play titled “20 yard pass”, and therefore the second play is displayed with higher priority than the first play. In some embodiments, the second play is the most recent play, and is displayed first, chronologically. Alternatively, in some embodiments, the plays are displayed in chronological order such that the earliest occurring play is displayed first and the latest occurring play is displayed last. In some embodiments, if the first drive is not the current drive, then the electronic device displays the play list in response to receiving an input to display an expanded view of the first drive. In some embodiments, if the first drive is the current drive, the electronic device displays the play list and updates the play list as additional plays are played in real time during the live event. Displaying the most recent play with higher priority than previous plays allows the user to view the most up to date information first, thereby reducing erroneous inputs to the electronic device.

In some embodiments, in accordance with the determination that the first drive includes the current play, the electronic device displays an expanded view of the indication of the first drive, such as the electronic device 500 displaying the plays on indication 922c but not indication 922b or 922a, as shown in FIG. 9H. In some embodiments, the drive with the current play is displayed with an expanded view. In some embodiments, as additional plays occur during the drive, indications of the respective additional plays are added to the expanded view of the first drive. In some embodiments, the expanded view includes information about each play of all the plays in the first drive, as described in more detail above. In some embodiments, the electronic device displays the plays chronologically in the expanded view wherein the most recent play (e.g., the current play) is displayed with higher priority than previously occurring plays.

In some embodiments, in accordance with a determination that the first drive does not include the current play, the electronic device displays a collapsed view of the indication of the first drive, such as displaying the collapsed view of indication 922a, shown in FIG. 9H. In some embodiments, after a drive is completed, the electronic device ceases displaying the expanded view and displays the collapsed view. In some embodiments, the collapsed view does not include a display of all the indications of plays of the respective drive. In some embodiments, the collapsed view includes a summary of the plays that occurred during the respective drive, as described below. Displaying an expanded view for the drive with the current play and not for drives that are not currently active allows the electronic device to efficiently allocate screen real estate for the more relevant drive.

In some embodiments, displaying the expanded view of the indication of the first drive includes displaying a summary of the first drive, such as shown by indication 922c in FIG. 9G. In some embodiments, the summary of the first drive is displayed with higher priority than the indications of the sequence of one or more plays of the first drive. In some embodiments, the summary of the first drive includes information about how many plays are in the drive, the distances traveled during the drive, and the total time of the drive. In some embodiments, the summary of the first drive includes overview information about the respective drive (e.g., number of passes during the drive, number of strikes, number of balls, number of violations, or other data relating to a drive).

In some embodiments, while displaying the summary of the first drive, the electronic device receives, via a network connection, an indication of a new play of the first drive, such as shown by the additions of new plays in indication 922c in FIG. 9H. In some embodiments, a new play occurs when the previous play (e.g., the current play) is complete. In some embodiments, a new play occurs after a timer of the event is resumed, after a timeout, or after a known break. In some embodiments, the network connect is a wireless or wired connection (e.g., WiFi, cellular network, Bluetooth, or other connection). In some embodiments, the new play occurs in real time during the event and the electronic device receives the indication of the new play.

In some embodiments, in response to receiving the indication of the new play, the electronic device updates the summary of the first drive to include information based on the new play, such as the electronic device 500 updating the summary of indication 822c, shown in FIG. 9H. In some embodiments, after receiving the indication of the new play, the electronic device updates the summary to include data relating to the new play. For example, the electronic device updates the number of plays that have occurred during the drive, the total time of the drive, and/or the distance covered during the drive. In some embodiments, the electronic device also updates the expanded view to include an indication of the new play, which is displayed higher than the previously occurred plays. Updating the summary of the first drive to include the most recent information about the plays allows the user to view relevant information about the event efficiently, thereby reducing erroneous inputs to the electronic device.

In some embodiments, the additional information about the first event includes one or more representations of one or more scoring drives of the first event and one or more representations of one or more drives including the one or more scoring drives and one or more additional drives (e.g., the one or more additional plays different from the one or more scoring plays as described in greater detail above). For example, when option 918a is selected, the electronic displays all drives, shown in FIG. 9H, and when option 918c is selected, the electronic device displays scoring drives, shown in FIG. 9K.

In some embodiments, while displaying the one or more representations of the one or more scoring drives without displaying the one or more representations of the one or more additional drives, the electronic device detects, via the one or more input devices, an input corresponding to a request to display the one or more representations of the one or more drives of the first event including the one or more scoring drives and the one or more additional drives, such as if the electronic device 500 receives a right swipe input directed towards user interface 906 in FIG. 9K to display the all drives view shown in FIG. 9J. In some embodiments, the input is a selection input, as described in greater detail above, directed towards a selectable option to display the one or more representations of the one or more drives. In some embodiments, the input is a swipe input directed towards the user interface (e.g., a tap and swipe with a finger, stylus, mouse, or other contact, a gaze and movement of eyes, and/or a voice command).

In some embodiments, in response to receiving the input, the electronic device displays the one or more representations of the one or more additional drives, such as shown by indications 922a through 922c, shown in FIG. 9H. In some embodiments, in response to receiving the input, the electronic device also maintains displaying the overview of the one or more scoring drives. In some embodiments, in response to receiving the input, the electronic device displays the one or more drives chronologically or in reverse-chronological order. In some embodiments, additional drives can occur between scoring drives, therefore in response to receiving the input, the electronic device updates the display of the drives to include the additional drives and the scoring drives such that they are ordered chronologically (e.g., from most recent drive to oldest drive, or vise versa). Including an option to view all drives or only scoring drives allows a user to quickly and efficiently view information about the event thereby reducing erroneous inputs to the electronic device.

In some embodiments, while displaying the visual representation of the first event including the location of the object used in the event, such as shown by representations 916a, 916d, and 916g in FIG. 9D, the electronic device receives, via a network connection, an indication of a movement of the object, such as an indication that a player has moved the ball to the endzone. In some embodiments, the organizations change possession of the object (e.g., which optionally means that the object moves physical locations or the object remains in the same physical location), the object moves in the venue of the event (e.g., the object moves to a different location on the field), or a combination of the above. In some embodiments, network connections are described with greater detail above.

In some embodiments, in response to receiving the indication of the movement of the object, the electronic device updates the visual representation of the first event to include the updated location of the object, such as shown by the electronic device 500 updating representations 916a, 916d, and 916g in FIG. 9E. In some embodiments, updating the visual representation includes updating the color and/or style of the visual representation (e.g., to indicate movement and/or change of ownership of the object). In some embodiments, updating the visual representation includes displaying the visual representation in a second location on the user interface. Updating the visual representation of the object in response to the object moving during a live event allows a user to better visualize the events occurring during the event thereby reducing the amount of erroneous inputs to the electronic device to see additional information about the event.

In some embodiments, while displaying the visual representation of the first event, the electronic device detects, via the one or more input devices, an input corresponding to a request to display second additional information about the first event, such as shown by input including contact 924a in FIG. 9F. In some embodiments, the input includes a scroll input having one or more characteristics of the scroll input described above. In some embodiments, the scroll input is directed towards the user interface corresponding to the first event. In some embodiments, in response to detecting the scroll input, the electronic device displays additional information that was not previously displayed on the user interface. In some embodiments, the second additional information has one or more characteristics of the additional information. In some embodiments, the second additional information is a continuation of information from the additional information.

In some embodiments, in response to detecting the input, the electronic device displays the second additional information about the first event, such as displaying indications 922a through 922c, shown in FIG. 9G. In some embodiments, the electronic device continues displaying the additional information while displaying the second additional information. In some embodiments, the electronic device displays portions of the additional information while displaying portions of the second additional information.

In some embodiments, in response to detecting the input, the electronic device ceases displaying the visual representation of the first event, such as no longer displaying representations 912 and 914 in FIG. 9G. In some embodiments, the electronic device does not display the planar representation of the first event, as described below.

In some embodiments, in response to detecting the input, the electronic device displays a second visual representation of the first event, such as representation 928, shown in FIG. 9G. In some embodiments, the electronic device displays the second visual representation, which is optionally a linear representation of the first event. In some embodiments, the second visual representation has one dimension (e.g., length) and the visual representation has two dimensions (e.g., length, width). In some embodiments, the second visual representation has two dimensions (e.g., length, width) and the visual representation has two dimensions (e.g., length, width). In some embodiments, the electronic device maintains the dimensionality in one dimension (e.g., length) when displaying the second visual representation. For example, the length of the field represented by the visual representation remains the same in the second visual representation. However, in some embodiments, the width of the second visual representation is different than the width of the visual representation. In some embodiments, the second visual representation has one or more characteristics of the visual representation and/or displays some or all of the information about the event that the visual representation of the first event displays. For example, the second visual representation includes indications of the object's movement, current location, and which organization has possession over the object. In some embodiments, the second visual representation occupies less area in the user interface than the visual representation. Displaying a smaller/concise version (e.g., the second visual representation) of the visual representation in response to receiving an input to view the second additional information allows the electronic device to still display the representation of the first event while conserving display real estate so that the user can view the second additional information.

In some embodiments, the second visual representation of the first event includes the location of the object used in the event and the movements of the object during the event, such as representations 926a through 926d, shown in FIG. 9G. In some embodiments, the location of the object and the movements of the object are described in greater detail above. In some embodiments, the location of the object is described relative to a venue of the event, such as relative to yard markings of a football field. Displaying the location of the object and movements of the object during a live event allows a user to better visualize the events occurring during the event thereby reducing the amount of erroneous inputs to the electronic device to see additional information about the event.

In some embodiments, the visual representation of the first event is a planar representation of the first event and the second visual representation of the first event is a linear representation of the first event, such as representation 914 being a rectangle with a length and a width, shown in FIG. 9F, and representation 928, shown in FIG. 9G being a bar shape without a width. In some embodiments, the planar representation of the first event includes a rectangular (e.g., a “3D”) representation of the venue of the event (e.g., a rectangular representation of a field) with depth. In some embodiments, the linear representation of the first event includes a line-like shape to represent the, venue of the event, without depth. For example, before the scroll input to view second additional information, the electronic device displays the field as a rectangle (e.g., with depth), and after the scroll input, the electronic device displays the field as a line (e.g., without depth). In some embodiments, while displaying the visual representation, the electronic device is able to display the object in any combination of an x (length) and a y (width) direction. However, in some embodiments, while displaying the second visual representation, the electronic device is only able to display the object in the corresponding x (length) direction, without the y direction. Displaying a smaller/concise version (e.g., the second visual representation) of the visual representation allows the electronic device to still display the representation of the first event while conserving display real estate so that the user can view other additional information.

In some embodiments, the visual representation of the first event includes a text indication of a current location of the object (e.g., a text description describing the current location of the object, a distance the object needs to move to satisfy one or more criteria (e.g., a first down or touchdown in football), and which organization is in possession of the object. In some embodiments, the text description is displayed with the visual representation or second visual representation, described above.), such as shown by representation 912, shown in FIG. 9D.

In some embodiments, in accordance with a determination that the current location of the object is within a threshold distance from a respective location within a venue of the event, the electronic device displays the text indication with a first visual characteristic, such as if the object represented by representation 916a, shown in FIG. 9D, were at a threshold distance from the endzone (e.g., the shaded area of representation 914, then representation 912 would have a first visual characteristic. In some embodiments, if the object is within a threshold distance of a location within the venue that would cause the drive to be a scoring drive, then the electronic device displays the text indication with a first visual characteristic. For example, the threshold distance is 5, 10, 20, 30, or 50 yards away from a scoring location (e.g., end zone or goal post). In some embodiments, the first visual characteristic includes displaying the text indication or a portion of the text indication (e.g., the current location and/or the distance to satisfy one or more criteria) with a first line thickness, a first font, or a first color.

In some embodiments, in accordance with a determination that the current location of the object is not within the threshold distance from the respective location within the venue of the event, the electronic device displays the text indication with a second visual characteristic, such as representation 912 shown in FIG. 9D. In some embodiments, the electronic device displays the text indication or a portion of the text indication (e.g., the current location and/or the distance to satisfy one or more criteria) with a second line thickness, a second font, or a second color. Displaying the text indication with a different visual characteristic when a team is close to scoring allows the user to efficiently identify key events during the event, thereby reducing erroneous inputs to the electronic device.

In some embodiments, the electronic device displays the representation of the object in the visual representation of the first event with a first visual characteristic, such as representation 916a, shown in FIG. 9D. In some embodiments, the representation of the object is displayed as an icon (e.g., an icon of a football, soccer ball, tennis ball, golf ball, baseball, or other objects). In some embodiments, the representation of the object is displayed with a first color, a first line thickness, and/or a first line pattern.

In some embodiments, the electronic device displays a visual indication of a previous location of the object at a start of a current play (or current drive) overlaid on the visual representation of the first event with a second visual characteristic, such as representation 916d, shown in FIG. 9D. In some embodiments, the visual indication of the previous location of the object is a dot. In some embodiments, the visual indication of the previous locations of the object is displayed with a second icon, second color, a second line thickness, and/or a second line pattern. For example, the electronic device displays a dot representing the location of the object at the start of the current play/drive and a line from the dot to the current location of the object, representing the movement of the object.

In some embodiments, the electronic device displays a textual indication of the current play, such as representation 912, shown in FIG. 9D. In some embodiments, the text indication described the current location of the object (e.g., relative to predefined locations within the venue of the event, such as yard lines on a football field), a distance the object needs to move to complete the drive, and which organization is in possession of the object. Displaying the previous location and current location of the object allows a user to better visualize the events occurring during the event thereby reducing the amount of erroneous inputs to the electronic device to see additional information about the event.

In some embodiments, the visual representation of the first event includes one or more graphical indications of predefined locations within a venue of the first event, such as representation 916e, shown in FIG. 9D. In some embodiments, the graphical indications of locations is presented as either planar or linear, described in greater detail above. In some embodiments, the graphical indication of locations within the venue includes one or more field lines (e.g., markings every 5 yards in the case of a football field) and/or markings that are also present in the real world venue of the first event. Displaying graphical indications of markings allows a user to better visualize the events occurring during the event thereby reducing the amount of erroneous inputs to the electronic device to see additional information about the event.

It should be understood that the particular order in which the operations in FIG. 10 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 800) are also applicable in an analogous manner to method 1000 described above with respect to FIG. 10. For example, the operation of displaying additional information about a play-by-play of an event including a representation of a current play described above with reference to method 1000 optionally has one or more of the characteristics of displaying a content user interface with event representations and displaying additional information about an event described herein with reference to other methods described herein (e.g., methods 700 and 800). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 8 are, optionally, implemented by components depicted in FIGS. 1A-1B. For example, displaying operation 802a, 802c, 802f, and 802g, and receiving operation 802d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing a user's clicks and/or views for a certain category and/or organization. Additionally, for example, transmitting a user's list of organizations between applications. Accordingly, use of such personal information data enables users to use electronic devices to view content (e.g., to view live content). Further, other uses for personal information data that benefit the user are also contemplated by the present disclosure. For instance, personal information data may be generate content to be played with the content sampler user interface.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device version tracks content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
receiving a list of organizations that have been designated by a user of the electronic device;
displaying, via the display generation component, a content user interface, wherein the content user interface includes:
a plurality of event representations in a first category, the plurality of event representations consisting of at least a first event representation having information about a first event and a second event representation having information about a second event, wherein:
in accordance with a determination that an organization associated with the first event is included in the list of organizations and an organization associated with the second event is not included in the list, the first event representation is displayed with higher priority than the second event representation in the content user interface; and
in accordance with a determination that the organization associated with the second event is included in the list and the organization associated with the first event is not included in the list, the second event representation is displayed with higher priority than the first event representation in the content user interface;
while displaying the content user interface, receiving, via the one or more input devices, an input to display a plurality of event representations in a second category different from the first category in the content user interface; and
in response to receiving the input:
ceasing displaying the plurality of event representations in the first category; and
displaying, in the content user interface, a plurality of event representations in the second category.

2. The method of claim 1, wherein an organization in the list of designated organizations is a sports team.

3. The method of claim 1, wherein an organization in the list of designated organizations is an association of sports teams.

4. The method of claim 1, wherein the first category is associated with one of one or more first associations of teams in the list of organizations or one or more first teams in the list of organizations and the second category is associated with another one, different from the first category, of the one or more first associations of teams in the list of organizations or the one or more first teams in the list of organizations.

5. The method of claim 1, wherein the plurality of event representations in the first category includes events on a first day and the plurality of event representations in the second category includes events on a second day different from the first day.

6. The method of claim 1, further comprising:
while displaying the plurality of event representations in the second category, receiving, via the one or more input devices, a second input; and
in response to receiving the second input:
cease displaying the plurality of event representations in the second category; and
displaying, in the content user interface, a plurality of event representations in a third category, different from the first category and the second category.

7. The method of claim 1, wherein the plurality of event representations are chronologically ordered.

8. The method of claim 1, wherein the plurality of event representations includes events ordered chronologically that are not associated with organizations in list of designated organizations.

9. The method of claim 1, further comprising:
while displaying a first plurality of event representations in the first category, receiving, via the one or more input devices, a second input corresponding to a request to scroll while displaying the content user interface; and
in response to receiving the second input:
in accordance with a determination that the second input corresponds to a request to scroll in a first direction, displaying, in the content user interface, a second plurality of event representations that occur at a later time than the first plurality of event representations; and
in accordance with a determination that the second input corresponds to a request to scroll in a direction opposite from the first direction, displaying, in the content user interface, a third plurality of event representations that occur at an earlier time than the first plurality of event representations.

10. The method of claim 1, further comprising:
while displaying a first representation of the first plurality of event representations and the first plurality of event representations in the first category, receiving, via the one or more input devices, a second input corresponding to a request to minimize the first plurality of event representations while in the content user interface; and
in response to receiving the second input:
ceasing displaying the first plurality of event representations in the first category; and
displaying a second representation of the first plurality of event representations in the first category, wherein the second representation is smaller in size than the first representation.

11. The method of claim 1, wherein the content user interface further comprises a first selectable option that is selectable to display a user interface element including a subset of a list of categories and a second selectable option that is selectable to display a second user interface including a view of the list of categories including a representation of the first category and a representation of the second category.

12. The method of claim 11, wherein:
in accordance with a determination that the first category includes more events than the second category, displaying, on the user interface element, the representation of the first category before the representation of the second category in the list of categories; and
in accordance with a determination that the second category includes more events than the first category, displaying, on the user interface element, the representation of the second category before the representation of the first category in the list of categories.

13. The method of claim 11, further comprising:
while displaying the second user interface including the view of the list of categories, receiving, via the one or more input devices, a second input directed towards the representation of the first category; and
in response to receiving the second input:
adding an organization associated with the first category to the list of organizations.

14. The method of claim 11, wherein the second user interface includes a plurality of representations of a plurality of organizations associated with the list of categories; and
the method further comprises:
while displaying the second user interface including the plurality of representations of the plurality of organizations, receiving, via the one or more input devices, a second input directed towards a selectable option directed towards a representation of a first organization; and
in response to receiving the second input:
adding the first organization to the list of organizations.

15. The method of claim 1, wherein:
in accordance with the determination that the organization associated with the first event is included in the list of organizations selected by the user:
displaying an indication next to the organization on the first event representation; and
in accordance with the determination that the organization associated with the first event is not included in the list of organizations selected by the user:
forgoing displaying the indication next to the organization.

16. The method of claim 1, further comprising receiving, via the one or more input devices, a second input directed towards the first event representation; and
in response to receiving the second input:
displaying a user interface corresponding to the first event that includes additional information about the first event not included in the information about the first event in the first event representation.

17. The method of claim 1, further comprising:
while displaying the content user interface, receiving, via the one or more input devices, a second input corresponding to a request to cease displaying the content user interface; and
in response to receiving the second input, ceasing displaying the content user interface;
after ceasing displaying the content user interface in response to receiving the second input:
receiving, via the one or more input devices, a third input corresponding to a request to redisplay the content user interface;
in response to receiving the third input:
redisplaying the content user interface, including:
in accordance with a determination that a first category of events has more relevance to the user than a second category of events based on one or more criteria, displaying plurality of representation of events in the first category with higher priority than a plurality of event representations in the second category; and
in accordance with the determination that the first category of events does not have more relevance to the user than a second category of events based on one or more criteria, forgoing displaying plurality of representation of events in the first category with higher priority than a plurality of event representations in the second category.

18. The method of claim 1, wherein the content user interface is associated with a first application, and the method further comprises:
sharing the list of organizations selected by the user of the electronic device with a second application different from the first application.

19. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
receiving a list of organizations that have been designated by a user of the electronic device;
displaying, via the display generation component, a content user interface, wherein the content user interface includes:
a plurality of event representations in a first category, the plurality of event representations consisting of at least a first event representation having information about a first event and a second event representation having information about a second event, wherein:
in accordance with a determination that an organization associated with the first event is included in the list of organizations and an organization associated with the second event is not included in the list, the first event representation is displayed with higher priority than the second event representation in the content user interface; and
in accordance with a determination that the organization associated with the second event is included in the list and the organization associated with the first event is not included in the list, the second event representation is displayed with higher priority than the first event representation in the content user interface;
while displaying the content user interface, receiving, via the one or more input devices, an input to display a plurality of event representations in a second category different from the first category in the content user interface; and
in response to receiving the input:
cease displaying the plurality of event representations in the first category; and
displaying, in the content user interface, a plurality of event representations in the second category.

20. A non-transitory computer readable storage medium storing one or more programs, the one or more programs comprising instructions, which when executed by one or more processors of an electronic device, cause the electronic device to perform a method comprising:
receiving a list of organizations that have been designated by a user of the electronic device;
displaying, via a display generation component, a content user interface, wherein the content user interface includes:
a plurality of event representations in a first category, the plurality of event representations consisting of at least a first event representation having information about a first event and a second event representation having information about a second event, wherein:
in accordance with a determination that an organization associated with the first event is included in the list of organizations and an organization associated with the second event is not included in the list, the first event representation is displayed with higher priority than the second event representation in the content user interface; and
in accordance with a determination that the organization associated with the second event is included in the list and the organization associated with the first event is not included in the list, the second event representation is displayed with higher priority than the first event representation in the content user interface;
while displaying the content user interface, receiving, via a one or more input devices, an input to display a plurality of event representations in a second category different from the first category in the content user interface; and
in response to receiving the input:
cease displaying the plurality of event representations in the first category; and
displaying, in the content user interface, a plurality of event representations in the second category.
